(19) United States
(12) Patent Application Publication
(10) Pub. No.: US 2026/0217916 A1
(43) Pub. Date: Jul. 30, 2026

(54) BLOCK COPOLYMER, PROCESS FOR PRODUCING BLOCK COPOLYMER, INSULATING MATERIAL, POLYIMIDE, AND PRINTED BOARD

(71) Applicant: Resonac Corporation, Tokyo (JP)

(72) Inventors: Tomoaki MAENO, Tokyo (JP); Yasunori KAWABATA, Tokyo (JP); Arisa HATAKEYAMA, Tokyo (JP)

(21) Appl. No.: 18/861,932

(22) PCT Filed: Mar. 14, 2024
(86) PCT No.: PCT/JP2024/009987

§ 371 Date: Oct. 31, 2024

(30) Foreign Application Priority Data
May 1, 2023 (WO) PCT/JP2023/017047

(51) Int. Cl. C08G 73/10

(52) U.S. Cl. CPC C08G 73/10

(57) ABSTRACT

The disclosure relates to a block copolymer including: a polyimide block (BI) and a polyamic acid block (BA); and a structural unit (X) having a group (X) that includes at least one non-aromatic hydrocarbon group, where the total number of carbon atoms in the at least one non-aromatic hydrocarbon group is nine or more.

### FIELD

The present disclosure relates to a block copolymer, a method for producing a block copolymer, an insulating material, a heat-resistant insulating material, a composition, a composition for an insulator, a composition for a heat-resistant insulator, a composition for a printed board, a polyimide, a compact, an insulator, a heat-resistant insulator, and a printed board.

### BACKGROUND

With spread of driving safety support system (DSSS), demand for vehicle-mounted millimeter wave radar is increasing. As an insulating material for a substrate for vehicle-mounted millimeter wave radar, there is a need for a resin having low loss of transmission signals and high heat resistance to withstand high temperatures near an engine. Polyimides are known as an insulating material having excellent heat resistance (Patent Literature 1).

### CITATION LIST

### Patent Literature

Patent Literature 1: WO 2010/113412

### SUMMARY

### Technical Problem

The present disclosure provides a block copolymer capable of obtaining a polyimide having a low permittivity, a low dielectric loss tangent, and a low coefficient of thermal expansion, and provides a method for producing a block copolymer. Further, the present disclosure provides a polyimide, a compact, an insulator, a heat-resistant insulator, and a printed board that exhibit excellent insulating properties or excellent heat resistance, or both, and an insulating material, a heat-resistant insulating material, a composition, a composition for an insulator, a composition for a heat-resistant insulator, and a composition for a printed board from which any of the above can be obtained.

### Solution to Problem

The present invention includes the following embodiments. The present invention is not limited to the following embodiments.

One embodiment relates to a block copolymer including: a polyimide block (BI) and a polyamic acid block (BA); and a structural unit (X) having a group (X) that includes at least one non-aromatic hydrocarbon group, where a total number of carbon atoms in the at least one non-aromatic hydrocarbon group is nine or more.

Another embodiment relates to a block copolymer including: the polyimide block (BI); the polyamic acid block (BA); and at least one selected from the group consisting of a structural unit represented by formula (XI) below and a structural unit represented by formula (XA) below.

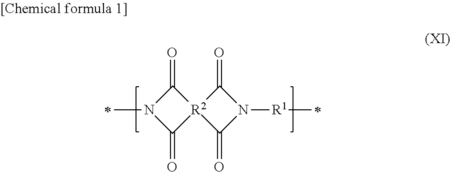

In the formula, R¹ and R² each independently represent an organic group, and at least one of R¹ and R² is a group (X) that includes at least one non-aromatic hydrocarbon group, where a total number of carbon atoms in the at least one non-aromatic hydrocarbon group is nine or more.

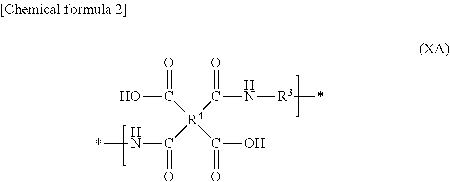

In the formula, R³ and R⁴ each independently represent an organic group, and at least one of R³ and R⁴ is a group (X) that includes at least one non-aromatic hydrocarbon group, where a total number of carbon atoms in the at least one non-aromatic hydrocarbon group is nine or more.

Another embodiment relates to a block copolymer including: a polyimide block (BI) and a polyamic acid block (BA); and a structure derived from a diamine or diisocyanate and a structure derived from a tetracarboxylic dianhydride, wherein at least one of the structure derived from a diamine or diisocyanate and the structure derived from a tetracarboxylic dianhydride includes a structure having a group (X) that includes at least one non-aromatic hydrocarbon group, where a total number of carbon atoms in the at least one non-aromatic hydrocarbon group is nine or more.

Another embodiment relates to a method for producing a block copolymer including: obtaining a polyimide (PI) by using a diamine or diisocyanate and a tetracarboxylic dianhydride; obtaining a polyamic acid (PA) by using a diamine and a tetracarboxylic dianhydride; and obtaining a block copolymer by using the polyimide (PI) and the polyamic acid (PA), wherein at least one selected from the group consisting of the diamine or diisocyanate and the tetracarboxylic dianhydride, which are used to obtain the polyimide (PI); and the diamine and the tetracarboxylic dianhydride, which are used to obtain the polyamic acid (PA), includes a compound having a group (X) that includes at least one non-aromatic hydrocarbon group, where a total number of carbon atoms in the at least one non-aromatic hydrocarbon group is nine or more.

Another embodiment relates to an insulating material and a heat-resistant insulating material, containing any of the above block copolymers.

Another embodiment relates to a composition, a composition for an insulator, a composition for a heat-resistant insulator, and a composition for a printed board, containing any of the above block copolymers or any of the above materials.

Another embodiment relates to a polyimide obtained using any of the above block copolymers, any of the above materials, or any of the above compositions.

Another embodiment relates to a compact, an insulator, and a heat-resistant insulator that are obtained using any of the above block copolymers, any of the above materials, or any of the above compositions, or include the above polyimide.

Another embodiment relates to a printed board that is obtained using any of the above block copolymers, any of the above materials, or any of the above compositions, or includes the above polyimide, the above compact, the above insulator, or the above heat-resistant insulator.

### Advantageous Effects of Invention

According to the present disclosure, it is possible to obtain a block copolymer capable of obtaining a polyimide having a low permittivity, a low dielectric loss tangent, and a low coefficient of thermal expansion, and to obtain a method for producing a block copolymer. According to the present disclosure, it is also possible to obtain a polyimide, a compact, an insulator, a heat-resistant insulator, and a printed board that exhibit excellent insulating properties or excellent heat resistance, or both, and an insulating material, a heat-resistant insulating material, a composition, a composition for an insulator, a composition for a heat-resistant insulator, and a composition for a printed board from which any of the above can be obtained.

### DESCRIPTION OF EMBODIMENTS

Embodiments of the present invention will be described. The present invention is not limited to the following embodiments. The following embodiments can be implemented alone or in combination. Combinations of multiple embodiments are also included in the present invention.

In numerical ranges described step by step in the present disclosure, an upper or lower limit of a numerical range may be replaced with an upper or lower limit of another numerical range. An upper or lower limit of a numerical range described in the present disclosure may be replaced with a value indicated in examples. A certain numerical value may be selected from the upper limit numerical values described step by step in the present disclosure, and a certain numerical value may be selected from the lower limit numerical values described step by step in the present disclosure, to form another step by step numerical range. An upper limit numerical value and a lower limit numerical value described in the present disclosure may be replaced with values indicated in examples.

In the present disclosure, each component may include multiple types of substances corresponding therewith. When there are multiple types of substances corresponding with each component in a composition, the content or amount contained of each component means, unless otherwise specified, the total content or the total amount contained of the multiple types of substances present in the composition.

In the present disclosure, each structure in a polymer may include multiple types of structures corresponding therewith. When there are multiple types of structures corresponding with each structure in a polymer, the content or amount contained of each structure means, unless otherwise specified, the total content or the total amount contained of the multiple types of structures present in the polymer.

In the present disclosure, the term “layer” includes a layer formed only in a portion of a region, in addition to a layer formed over the entire region, when the region where the layer is present is observed. The same applies to “membrane”.

### <Block Copolymer>

In one or more embodiments of the present invention, the block copolymer includes a polyimide block (BI) and a polyamic acid block (BA). The block copolymer includes a group (X) that includes at least one non-aromatic hydrocarbon group, where the total number of carbon atoms in the at least one non-aromatic hydrocarbon group is nine or more. In the present disclosure, “group (X) that includes at least one non-aromatic hydrocarbon group, where the total number of carbon atoms in the at least one non-aromatic hydrocarbon group is nine or more” may be referred to simply as “group (X)” or “hydrocarbon group (X)”.

The polyamic acid block (BA) may be a block that forms a polyimide block (BI-A) different from the polyimide block (BI) due to cyclization of an amic acid linkage. The block copolymer may further include an optional block different from the polyimide block (BI) and the polyamic acid block (BA). The block copolymer may include one type, or two or more types, of optional blocks.

In the present disclosure, whether blocks are the same or different can be distinguished by a structural unit included in the blocks. For example, if there is a structural unit included in one block but not in the other block, they are different blocks. Examples of a combination of two different blocks include the following cases: block 1 includes structural unit 1, and block 2 includes structural unit 2; block 1 includes structural unit 1, and block 2 includes structural unit 1 and structural unit 2; and block 1 includes structural unit 1 and structural unit 2, and block 2 includes structural unit 1 and structural unit 3. Structural unit 1, structural unit 2, and structural unit 3 used here are different structural units from each other. In the present disclosure, the number of types of structural units included in each block is not limited to one or two, and may be three or more. In the present disclosure, the number of types of blocks included in the block copolymer is not limited to two, and may be three or more.

The block copolymer including the polyimide block (BI) and the polyamic acid block (BA) includes an imide linkage (also referred to as “imide group”) and an amic acid linkage (also referred to as “amic acid structure” or “amic acid group”) in a polymer chain. The hydrocarbon group (X) may be a group positioned between the imide group and the imide group, between the amic acid group and the amic acid group, or between the imide group and the amic acid group. The block copolymer can include one type, or two or more types of hydrocarbon group (X).

Since the copolymer has a block structure, a polyimide having a low coefficient of thermal expansion can be obtained. Since the block copolymer has the hydrocarbon group (X), a polyimide having a low permittivity and a low dielectric loss tangent can be obtained. Further, since the block copolymer has the hydrocarbon group (X), a polyimide having a low water absorption percentage can be easily obtained.

### [Block Copolymer Including Structural Unit (X)]

In one or more embodiments of the present invention, the block copolymer includes a polyimide block (BI) and a polyamic acid block (BA), and includes a structural unit (X) that has a group (X). In the present disclosure, “structural unit (X) having a group (X) that includes at least one non-aromatic hydrocarbon group, where the total number of carbon atoms in the at least one non-aromatic hydrocarbon group is nine or more” may be simply referred to as “structural unit (X)”.

The block copolymer may include a structural unit other than the structural unit (X). An example of the structural unit other than the structural unit (X) is a structural unit (Y) below. The structural unit (Y) is a structural unit that does not include the hydrocarbon group (X).

In the block copolymer, only one of the polyimide block (BI) and the polyamic acid block (BA) includes the structural unit (X), or both of the polyimide block (BI) and the polyamic acid block (BA) include the structural unit (X). The polyimide block (BI) and the polyamic acid block (BA) may each independently include one type, or two or more types, of structural units (X). When the block copolymer includes the structural unit (Y), only one of the polyimide block (BI) and the polyamic acid block (BA) may include the structural unit (Y), or both of the polyimide block (BI) and the polyamic acid block (BA) may include the structural unit (Y). The polyimide block (BI) and the polyamic acid block (BA) may each independently include one type, or two or more types of structural units (Y).

### (Structural Unit (X))

The structural unit (X) includes at least a hydrocarbon group (X). The structural unit (X) may further include at least one of an imide group and an amic acid group. The number of carbon atoms included in the imide group and the amic acid group is not taken as part in the total number of carbon atoms in the at least one non-aromatic hydrocarbon group in the hydrocarbon group (X). For example, the structural unit (X) is a structural unit that includes a hydrocarbon group (X), and an imide group or an amic acid group. The block copolymer may include the hydrocarbon group (X) included in the structural unit (X), and the imide group or the amic acid group, in a polymer chain. The structural unit (X) may include one type, or two or more types of hydrocarbon group (X). The structural unit (X) may further include an optional group other than the hydrocarbon group (X), the imide group, and the amic acid group. An example of the optional group is an organic group that does not correspond with the hydrocarbon group (X). In the present disclosure, an organic group is a group including at least one carbon atom. In the present disclosure, an organic group that is other than the hydrocarbon group (X) and does not correspond with the hydrocarbon group (X) may be referred to as “organic group (Y)”. The organic group (Y) may be a group positioned between the imide group and the imide group, between the amic acid group and the amic acid group, or between the imide group and the amic acid group. The block copolymer may include the organic group (Y) in a polymer chain.

### (Hydrocarbon Group (X))

The hydrocarbon group (X) includes at least one non-aromatic hydrocarbon group. In the hydrocarbon group (X), the total number of carbon atoms in the at least one non-aromatic hydrocarbon group is nine or more. When the hydrocarbon group (X) includes one non-aromatic hydrocarbon group, the total number of carbon atoms means the number of all carbon atoms included in the one non-aromatic hydrocarbon group. When the hydrocarbon group (X) includes two or more non-aromatic hydrocarbon groups, the total number of carbon atoms means the number of all carbon atoms included in the two or more non-aromatic hydrocarbon groups. When the hydrocarbon group (X) includes two or more non-aromatic hydrocarbon groups, the non-aromatic hydrocarbon groups may be the same or different from each other. The hydrocarbon group (X) may further include an optional group other than the non-aromatic hydrocarbon group. The hydrocarbon group (X) is, for example, a monovalent to tetravalent group. The structural unit (X) preferably includes a divalent to tetravalent hydrocarbon group (X), more preferably a divalent or tetravalent hydrocarbon group (X), and even more preferably a divalent hydrocarbon group (X).

The non-aromatic hydrocarbon group is a hydrocarbon group that does not include an aromatic ring and is non-aromatic. The non-aromatic hydrocarbon group is, for example, a saturated aliphatic hydrocarbon group, an unsaturated aliphatic hydrocarbon group, a saturated alicyclic hydrocarbon group, an unsaturated alicyclic hydrocarbon group, or a group consisting of two or more selected from these. The saturated aliphatic hydrocarbon group may be linear or branched. The unsaturated aliphatic hydrocarbon group may be linear or branched. When the hydrocarbon group (X) includes two or more non-aromatic hydrocarbon groups, the two or more non-aromatic hydrocarbon groups may be the same or different from each other.

Examples are given below of the hydrocarbon group (X) and the total number of carbon atoms in the at least one non-aromatic hydrocarbon group included in the hydrocarbon group (X). Examples are given below of the organic group (Y) and the total number of carbon atoms in the at least one non-aromatic hydrocarbon group included in the organic group (Y), as reference examples. As described below, the number of carbon atoms included in a —C(O)-group is not taken as part in the total number of carbon atoms. In the present disclosure, “*” in formulas represents a bonding position with another atom.

TABLE 1

| | | Number of |
|---|---|---|
| | Group | carbon atoms |
| Hydrocarbon group (X) | 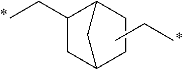 | 9 |
| | 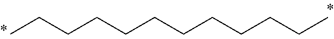 | 10 |
| | 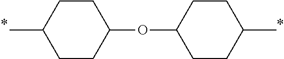 | 12 |
| | 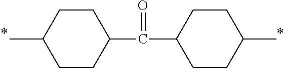 | 12 |
| | 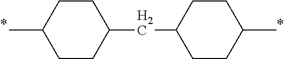 | 13 |
| | 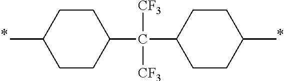 | 15 |
| | 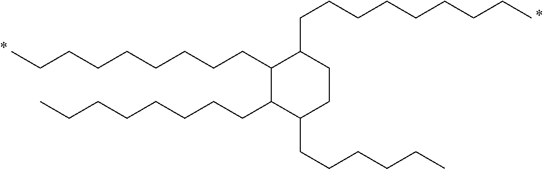 [SMILES: CCCCCCCCCC1CCC(CCCCCC)C(CCCCCCCC)C1CCCCCCCCC] | 36 |
| Organic group (Y) | 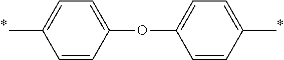 | 0 |
| | 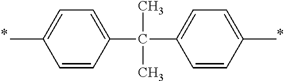 | 3 |
| | 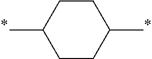 | 6 |

The total number of carbon atoms in the at least one non-aromatic hydrocarbon group included in the hydrocarbon group (X) may be within a range from 9 to 50. The number of carbon atoms may be, for example, 12 or more, 16 or more, 20 or more, 24 or more, 28 or more, 32 or more, or 36 or more. The number of carbon atoms may be, for example, 48 or less, 44 or less, 40 or less, or 36 or less. The number of carbon atoms may be, for example, within a range from 12 to 48, from 20 to 44, or from 28 to 40. When the total number of carbon atoms in the non-aromatic hydrocarbon group is nine or more, it is thought that a polyimide having a low permittivity and a low dielectric loss tangent can be obtained because of an increase in free volume, a decrease in polarity, and the like. When the total number of carbon atoms in the non-aromatic hydrocarbon group is 50 or less, good solubility in solvents can be maintained. Even if the block copolymer has a group where the total number of carbon atoms in an aromatic hydrocarbon group and a heteroaromatic ring compound group is nine or more, instead of the hydrocarbon group (X), a polyimide having a low permittivity and a low dielectric loss tangent cannot be obtained because of a small free volume.

Examples are given below of a saturated aliphatic hydrocarbon group, an unsaturated aliphatic hydrocarbon group, a saturated alicyclic hydrocarbon group, an unsaturated alicyclic hydrocarbon group, and a group consisting of two or more selected from these groups, which the hydrocarbon group (X) can include. The following examples can be applied to the saturated aliphatic hydrocarbon group, the unsaturated aliphatic hydrocarbon group, the saturated alicyclic hydrocarbon group, the unsaturated alicyclic hydrocarbon group, and the group consisting of two or more selected from these groups in the present disclosure.

The number of carbon atoms in a saturated aliphatic hydrocarbon group is, for example, within a range from 1 to 50, from 2 to 40, from 3 to 30, from 4 to 20, or from 5 to 10. The saturated aliphatic hydrocarbon group is, for example, an atomic group obtained by removing one to four hydrogen atoms from a linear or branched alkane. Examples of the alkane include methane, ethane, propane, butane, pentane, hexane, heptane, octane, nonane, decane, undecane, dodecane, tridecane, tetradecane, pentadecane, hexadecane, heptadecane, octadecane, nonadecane, eicosane, heneicosane, docosane, tricosane, tetracosane, hexacosane, octacosane, triacontane, tetracontane, and pentacontane.

The number of carbon atoms in an unsaturated aliphatic hydrocarbon group is, for example, within a range from 2 to 50, from 2 to 40, from 3 to 30, from 4 to 20, or from 5 to 10. The number of a carbon-carbon unsaturated bond included in the unsaturated aliphatic hydrocarbon group is one or more, and may be, for example, five or less, four or less, three or less, or two or less. The unsaturated aliphatic hydrocarbon group may be an alkene including one carbon-carbon double bond, or an alkyne including one carbon-carbon triple bond. The unsaturated aliphatic hydrocarbon group may be, for example, an atomic group obtained by removing one to four hydrogen atoms from a linear or branched alkene, or an atomic group obtained by removing one to four hydrogen atoms from a linear or branched alkyne. Examples of alkenes include ethene, propene, butene, pentene, hexene, heptene, octene, nonene, decene, undecene, dodecene, tridecene, tetradecene, pentadecene, hexadecene, heptadecene, octadecene, nonadecene, eicosene, heneicosene, docosene, tricosene, tetracosene, pentacosene, hexacosene, heptacosene, octacosene, nonacosene, triacontene, tetracontene, and pentacontene. Examples of alkynes include ethyne, propyne, butyne, pentyne, hexyne, heptyne, octyne, nonyne, decyne, undecyne, dodecyne, tridecyne, tetradecyne, pentadecyne, hexadecyne, heptadecyne, octadecyne, nonadecyne, eicosyne, heneicosyne, docosyne, tricosyne, tetracosyne, pentacosyne, hexacosyne, heptacosyne, octacosyne, nonacosyne, triacontyne, tetracontyne, and pentacontyne.

The number of carbon atoms in the saturated alicyclic hydrocarbon group is, for example, within a range from 3 to 20, from 4 to 16, from 5 to 10, or from 6 to 8. The saturated alicyclic hydrocarbon group is, for example, an atomic group obtained by removing one to four hydrogen atoms from a cycloalkane. Examples of the cycloalkane include cyclopropane, cyclobutane, cyclopentane, cyclohexane, cycloheptane, cyclooctane, norbornane, decalin, bicyclobutane, bicyclohexane, bicyclooctane, spiropentane, spiroheptane, guadricyclane, and adamantane.

The number of carbon atoms in the unsaturated alicyclic hydrocarbon group is, for example, within a range from 4 to 20, from 5 to 10, or from 6 to 8. The number of carbon-carbon unsaturated bonds included in the unsaturated aliphatic hydrocarbon group is one or more, and may be, for example, five or less, four or less, three or less, or two or less. The unsaturated aliphatic hydrocarbon may be a cycloalkene including one carbon-carbon double bond, or a cycloalkyne including one carbon-carbon triple bond. The unsaturated alicyclic hydrocarbon group is, for example, an atomic group obtained by removing one to four hydrogen atoms from a cycloalkene, or an atomic group obtained by removing one to four hydrogen atoms from a cycloalkyne. Examples of the unsaturated alicyclic hydrocarbon include cyclobutene, cyclopentene, cyclopentadiene, cyclohexene, cyclohexadiene, cycloheptene, norbornene, norbornadiene, and bicyclooctadiene.

The number of carbon atoms in the group consisting of two or more selected from these is, for example, within a range from 4 to 50, from 9 to 50, from 16 to 48, from 24 to 44, or from 32 to 40. The group consisting of two or more selected from these includes two or more groups selected from the group consisting of: a saturated aliphatic hydrocarbon group; an unsaturated aliphatic hydrocarbon group; a saturated alicyclic hydrocarbon group; and an unsaturated alicyclic hydrocarbon group, where the two or more groups are bonded to each other. The group having two or more selected from these includes, for example, at least one selected from the group consisting of: a group consisting of a saturated aliphatic hydrocarbon group and a saturated alicyclic hydrocarbon group; a group consisting of a saturated aliphatic hydrocarbon group and an unsaturated alicyclic hydrocarbon group; a group consisting of an unsaturated aliphatic hydrocarbon group and a saturated alicyclic hydrocarbon group: and a group consisting of an unsaturated aliphatic hydrocarbon group and an unsaturated alicyclic hydrocarbon group.

Examples of an optional group that can be included in the hydrocarbon group (X) include an aromatic hydrocarbon group, an aromatic heterocyclic compound group, and a group containing a heteroatom. The following examples may be applied to the aromatic hydrocarbon group, the aromatic heterocyclic compound group, and the group containing a heteroatom in the present disclosure.

The number of carbon atoms in the aromatic hydrocarbon group is, for example, within a range from 6 to 30, from 6 to 20, or from 6 to 10. The aromatic hydrocarbon group is, for example, an atomic group obtained by removing one to four hydrogen atoms from an aromatic hydrocarbon. Examples of the aromatic hydrocarbon include benzene, naphthalene, anthracene, pyrene, and pentane. The number of carbon atoms in the aromatic heterocyclic compound group is, for example, within a range from 2 to 30, from 4 to 20, or from 5 to 10. The aromatic heterocyclic compound group is, for example, an atomic group obtained by removing one to four hydrogen atoms from an aromatic heterocyclic compound. Examples of the aromatic heterocyclic compound include pyridine, furan, benzofuran, thiophene, and benzothiophene.

Examples of the group containing a heteroatom include: a linking group (however, an imide group and an amic acid group are excluded) containing a heteroatom; and a substituent containing a heteroatom. Examples of the linking group containing a heteroatom include an oxy group, a thio group, a sulfonyl group, a sulfinyl group, a carbonyl group, a carbonyloxy group, and an imino group. Examples of the substituent containing a heteroatom include a hydroxy group, a mercapto group, a sulfo group, a sulfino group, a carboxy group, a fluoro group, and a chloro group. In the present disclosure, the number of carbon atoms in a —C(O)-group included in the group containing a heteroatom is not taken as part in the total number of carbon atoms in the at least one non-aromatic hydrocarbon group.

For example, the hydrocarbon group (X) consisting of a non-aromatic hydrocarbon group where the number of carbon atoms is nine or more. When the hydrocarbon group (X) consists of the non-aromatic hydrocarbon group, the hydrocarbon group (X) does not include any of the aromatic hydrocarbon group, the aromatic heterocyclic compound group, and the group containing a heteroatom. The hydrocarbon group (X) is: a saturated aliphatic hydrocarbon group where the number of carbon atoms is nine or more; an unsaturated aliphatic hydrocarbon group where the number of carbon atoms is nine or more; a saturated alicyclic hydrocarbon group where the number of carbon atoms is nine or more; an unsaturated alicyclic hydrocarbon group where the number of carbon atoms is nine or more; or a group consisting of two or more selected from a saturated aliphatic hydrocarbon group, an unsaturated aliphatic hydrocarbon group, a saturated alicyclic hydrocarbon group, and an unsaturated alicyclic hydrocarbon group, and where the number of carbon atoms is nine or more, for example. The saturated aliphatic hydrocarbon group may be linear or branched. The unsaturated aliphatic hydrocarbon group may be linear or branched. When the hydrocarbon group (X) consists of the non-aromatic hydrocarbon group where the number of carbon atoms is nine or more, the concentration of a polar group included in the block copolymer is easily reduced.

The hydrocarbon group (X) preferably includes at least one selected from the group consisting of a saturated alicyclic hydrocarbon group, and an unsaturated alicyclic hydrocarbon group, and more preferably includes a saturated alicyclic hydrocarbon group. When the block copolymer includes at least one of the saturated alicyclic hydrocarbon group and the unsaturated alicyclic hydrocarbon group, a polyimide having a lower permittivity tends to be easily obtained. The reason is presumed to be that the polyimide has an alicyclic structure, and thus the free volume increases. However, the present invention is not limited by the above presumption.

The hydrocarbon group (X) preferably includes at least one selected from the group consisting of a linear saturated aliphatic hydrocarbon group where the number of carbon atoms is six or more, and a linear unsaturated aliphatic hydrocarbon group where the number of carbon atoms is six or more, and more preferably includes a linear saturated aliphatic hydrocarbon group where the number of carbon atoms is six or more. When the block copolymer includes at least one of the linear saturated aliphatic hydrocarbon group where the number of carbon atoms is six or more, and the linear unsaturated aliphatic hydrocarbon group where the number of carbon atoms is six or more, a polyimide having a lower dielectric loss tangent tends to be easily obtained. It is presumed that the reason for this is that the concentration of the imide group in the polyimide decreases because the polyimide has a long chain structure, that is, the number of polar groups in the polyimide relatively decreases. However, the present invention is not limited by the above presumption.

In one or more embodiments, the total number of carbon atoms in the saturated aliphatic hydrocarbon group and the unsaturated aliphatic hydrocarbon group, which are included in the hydrocarbon group (X), may be more than the total number of carbon atoms in the saturated alicyclic hydrocarbon group and the unsaturated alicyclic hydrocarbon group, which are included in the hydrocarbon group (X).

In one or more embodiments, the hydrocarbon group (X) may not include the aromatic hydrocarbon group and the aromatic heterocyclic group.

The hydrocarbon group (X) preferably includes a group represented by formula (G1) below.

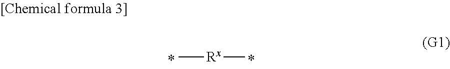

In the formula, R^{x} represents a group (X) that includes at least one non-aromatic hydrocarbon group, where a total number of carbon atoms in the at least one non-aromatic hydrocarbon group is nine or more.

The hydrocarbon group (X) more preferably includes at least one selected from the group consisting of a group represented by formula (G2), a group represented by formula (G3), a group represented by formula (G4), a group represented by formula (G5), and a group represented by formula (G6).

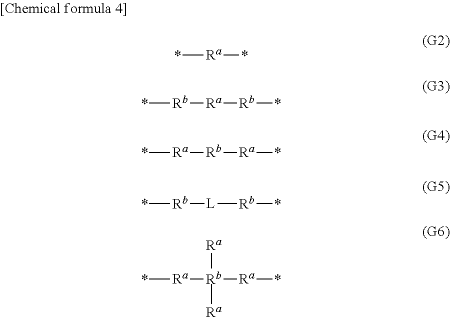

In the formulas, each R^{a} independently represents a linear or branched saturated aliphatic hydrocarbon group (the number of carbon atoms is, for example, one or more, six or more, or eight or more), or a linear or branched unsaturated aliphatic hydrocarbon group (the number of carbon atoms is, for example, one or more, six or more, or eight or more), and preferably represents a linear saturated aliphatic hydrocarbon group (the number of carbon atoms is, for example, one or more, six or more, or eight or more), or a linear unsaturated aliphatic hydrocarbon group (the number of carbon atoms is, for example, one or more, six or more, or eight or more). Each R^{b} independently represents a saturated alicyclic hydrocarbon group, or an unsaturated alicyclic hydrocarbon group, and preferably represents a saturated alicyclic hydrocarbon group (the number of carbon atoms is, for example, six (cyclohexane group) or seven (norbornane group)). L represents a single bond or a linking group (however, an imide group and an amic acid group are excluded) containing a heteroatom. R^{a} and R^{b} may or may not each independently have a substituent. The upper limit of the number of carbon atoms in R^{a} and R^{b} is, for example, 48 or less, 44 or less, 40 or less, or 36 or less.

The hydrocarbon group (X) further preferably includes at least one selected from the group consisting of a group represented by formula (G7), a group represented by formula (G8), and a group represented by formula (G9). These groups can be introduced into a block copolymer by using, for example, a dimer diamine as a monomer for obtaining the block copolymer. The hydrocarbon group (X) particularly preferably includes a group represented by formula (G8). When the structural unit (X) includes at least one selected from the group consisting of a group represented by formula (G7), a group represented by formula (G8), and a group represented by formula (G9), sufficient effects tend to be easily obtained of a low permittivity, a low dielectric loss tangent, and a low coefficient of thermal expansion.

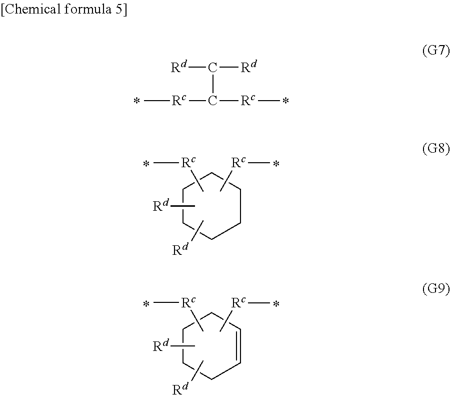

In the formulas, each R^{c} independently represents a linear alkylene group or a linear alkenylene group (the number of carbon atoms is, for example, six or more, eight or more, or nine or more), and each R^{d} independently represents a linear alkyl group or a linear alkenyl group (the number of carbon atoms is, for example, six or more, eight or more, or nine or more). R^{c} and R^{d} may or may not each independently have a substituent. The upper limit of the number of carbon atoms in R^{c} and R^{d} is, for example, 48 or less, 44 or less, 40 or less, or 36 or less.

### (Organic Group (Y))

The structural unit (X) can include an organic group (Y). The organic group (Y) is, for example, a group including at least one selected from the group consisting of: a saturated aliphatic hydrocarbon group; an unsaturated aliphatic hydrocarbon group; a saturated alicyclic hydrocarbon group; an unsaturated alicyclic hydrocarbon group; an aromatic hydrocarbon group; an aromatic heterocyclic compound group; and a group consisting of two or more selected from these groups. When the organic group (Y) includes at least one non-aromatic hydrocarbon group, the total number of carbon atoms included in the at least one non-aromatic hydrocarbon group is eight or less. The organic group (Y) preferably includes an aromatic hydrocarbon group. The organic group (Y) may further include a linking group containing a heteroatom, or a substituent containing a heteroatom. The organic group (Y) is, for example, a monovalent to tetravalent group. The structural unit (X) preferably includes a divalent to tetravalent organic group (Y), more preferably a divalent or tetravalent organic group (Y), and even more preferably a tetravalent organic group (Y).

The organic group (Y) preferably includes a group represented by formula (G11) below.

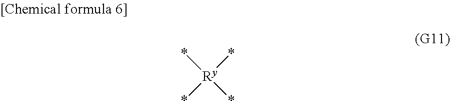

In the formula, R^{y} represents an organic group (Y).

The organic group (Y) more preferably includes at least one selected from the group consisting of a group represented by formula (G12), a group represented by formula (G13), and a group represented by formula (G14).

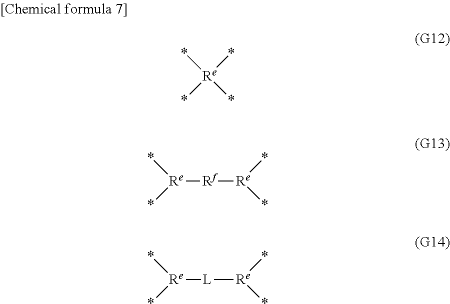

In the formulas, each R^{e} independently represents an aromatic hydrocarbon group or an aromatic heterocyclic compound group, preferably an aromatic hydrocarbon group, and more preferably a benzene group. R^{f} represents a linear or branched saturated aliphatic hydrocarbon group, or a linear or branched unsaturated aliphatic hydrocarbon group. The number of carbon atoms in R^{f} is eight or less. L represents a single bond or a linking group (however, an imide group and an amic acid group are excluded) containing a heteroatom. R^{e} and R^{f} may or may not each independently have a substituent.

According to one or more embodiments, the organic group (Y) includes at least one selected from the group consisting of a group represented by formula (G12) and a group represented by formula (G14), and preferably includes at least one selected from the group consisting of a group represented by formula (12) where R^{e} is a benzene group, and a group represented by formula (14) where R^{e} is a benzene group, and L is a single bond or a linking group (e.g., a carbonyl group) containing a heteroatom. For example, the organic group (Y) includes a group represented by formula (12) where R^{e} is a benzene group. For example, the organic group (Y) includes a group represented by formula (14) where R^{e} is a benzene group, and L is a single bond. For example, the organic group (Y) includes a group represented by formula (14) where R^{e} is a benzene group, and L is a linking group (e.g., a carbonyl group) containing a heteroatom.

Examples of the structural unit (X) include a structural unit represented by formula (XI) and a structural unit represented by formula (XA). In a preferred embodiment, the structural unit (X) includes at least one selected from the group consisting of a structural unit represented by formula (XI) and a structural unit represented by formula (XA). An example of the structural unit (X) is a structural unit (Xd) below. In a preferred embodiment, the structural unit (X) includes a structural unit (Xd).

### (Structural Unit (Y))

The block copolymer can include the structural unit (Y). The structural unit (Y) does not include the hydrocarbon group (X). The structural unit (Y) may include, for example, the organic group (Y) described above. The structural unit (Y) may further include at least one of an imide group and an amic acid group. For example, the structural unit (Y) is a structural unit that includes an organic group (Y), and an imide group or an amic acid group. The block copolymer may include the organic group (Y) included in the structural unit (Y), and the imide group or the amic acid group, in a polymer chain. The structural unit (Y) may include one type, or two or more types of organic groups (Y).

According to one or more embodiments, in the structural unit (Y), the organic group (Y) preferably includes a group represented by formula (G11) above, and a group represented by formula (G15) below, and more preferably includes: at least one selected from the group consisting of a group represented by formula (G12) above, a group represented by formula (G13) above, and a group represented by formula (G14) above; and at least one selected from the group consisting of a group represented by formula (G16) below, a group represented by formula (G17) below, and a group represented by formula (G18) below.

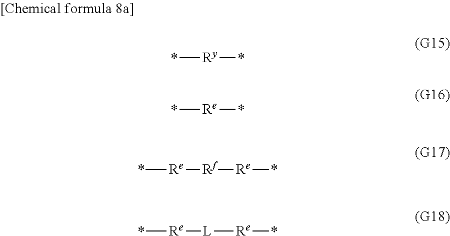

In the formulas, R^{y} represents an organic group (Y). R^{e} independently represents an aromatic hydrocarbon group or an aromatic heterocyclic compound group, preferably an aromatic hydrocarbon group, and more preferably a benzene group. R^{f} represents a linear or branched saturated aliphatic hydrocarbon group, or a linear or branched unsaturated aliphatic hydrocarbon group. The number of carbon atoms in R^{f} is eight or less. L represents a single bond or a linking group (however, an imide group and an amic acid group are excluded) containing a heteroatom. R^{e} and R^{f} may or may not each independently have a substituent.

According to one or more embodiments, in the structural unit (Y), the organic group (Y) includes: for example, at least one selected from the group consisting of a group represented by formula (G12) above, a group represented by formula (G13) above, and a group represented by formula (G14) above; and at least one selected from the group consisting of a group represented by formula (G16) above, a group represented by formula (G17) above, a group represented by formula (G18) above, a group represented by formula (G18a) below, and a group represented by formula (G18b) below, and preferably includes: at least one selected from the group consisting of a group represented by formula (G12) above and a group represented by formula (G14) above; and at least one selected from the group consisting of a group represented by formula (G16) above, a group represented by formula (G18) above, and a group represented by formula (G18b) below.

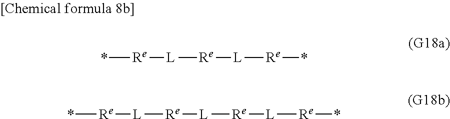

In the formulas, R^{e} each independently represents an aromatic hydrocarbon group or an aromatic heterocyclic compound group, preferably an aromatic hydrocarbon group, and more preferably a benzene group. L represents a single bond or a linking group (however, an imide group and an amic acid group are excluded) containing a heteroatom. R^{e} may or may not each independently have a substituent.

Examples of the structural unit (Y) include a structural unit represented by formula (YI) below, and a structural unit represented by formula (YA) below. In a preferred embodiment, the structural unit (Y) includes at least one selected from the group consisting of a structural unit represented by formula (YI) and a structural unit represented by formula (YA). An example of the structural unit (Y) is a structural unit (Yd) below. In a preferred embodiment, the structural unit (Y) includes the structural unit (Yd).

[Block Copolymer Including Structural Unit Represented by Formula (XI) and/or Structural Unit Represented by Formula (XA)]

In one or more embodiments of the present invention, the block copolymer includes a polyimide block (BI) and a polyamic acid block (BA), and includes at least one selected from the group consisting of a structural unit represented by formula (XI) and a structural unit represented by formula (XA). Examples of the block copolymer include a block copolymer where the polyimide block (BI) includes a structural unit represented by formula (XI); a block copolymer where the polyamic acid block (BA) includes a structural unit represented by formula (XA); a block copolymer where the polyimide block (BI) includes a structural unit represented by formula (XI), and the polyamic acid block (BA) includes a structural unit represented by formula (XA).

The block copolymer may include a structural unit other than the structural unit represented by formula (XI) below and the structural unit represented by formula (XA) below. Examples of the structural unit other than the structural unit represented by formula (XI) below and the structural unit represented by formula (XA) below include a structural unit represented by formula (YI) below and a structural unit represented by formula (YA) below. The block copolymer can include at least one selected from the group consisting of a structural unit represented by formula (YI) and a structural unit represented by formula (YA). The structural unit represented by formula (YI) and the structural unit represented by formula (YA) do not include the hydrocarbon group (X).

The structural unit represented by formula (XI) and the structural unit represented by formula (XA) correspond with the structural unit (X), and an example of the structural unit represented by formula (XI) and the structural unit represented by formula (XA) is a structural unit (Xd) below. The structural unit represented by formula (YI) and the structural unit represented by formula (YA) correspond with the structural unit (Y), and an example of the structural unit represented by formula (YI) and the structural unit represented by formula (YA) is a structural unit (Yd) below.

### (Structural Unit Represented by Formula (XI))

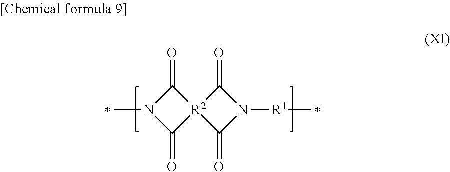

In the formula, R¹ and R² each independently represent an organic group, and at least one of R¹ and R² is a hydrocarbon group (X).

Examples of the organic group include the hydrocarbon group (X) and the organic group (Y).

According to one or more embodiments, in a structural unit represented by formula (XI), for example, R¹ is the hydrocarbon group (X), and R² is the organic group (Y). Preferably, R¹ is a group selected from the group consisting of: a group represented by formula (G2); a group represented by formula (G3); a group represented by formula (G4); a group represented by formula (G5); and a group represented by formula (G6), and R² is a group selected from the group consisting of: a group represented by formula (G12); a group represented by formula (G13); and a group represented by formula (G14). More preferably, R¹ is a group selected from the group consisting of: a group represented by formula (G4); a group represented by formula (G7); a group represented by formula (G8); and a group represented by formula (G9), and R² is a group represented by formula (G12). Even more preferably, R¹ is a group represented by formula (G8), and R² is a group represented by formula (G12) where R^{e} is a benzene group.

According to one or more embodiments, in a structural unit represented by formula (XI), for example, R¹ is a group selected from the group consisting of: a group represented by formula (G2); a group represented by formula (G3); a group represented by formula (G4); a group represented by formula (G5); and a group represented by formula (G6), and R² is a group selected from the group consisting of: a group represented by formula (G12); a group represented by formula (G13); and a group represented by formula (G14). Preferably, R¹ is a group selected from the group consisting of: a group represented by formula (G4); a group represented by formula (G7); a group represented by formula (G8); and a group represented by formula (G9), and R² is a group selected from the group consisting of a group represented by formula (G12) and a group represented by formula (G14). For example, a structural unit represented by formula (XI) includes a structural unit where R¹ is a group represented by formula (G8), and R² is a group represented by formula (G12) (R^{e} is a benzene group). For example, a structural unit represented by formula (XI) includes a structural unit where R¹ is a group represented by formula (G8), and R² is a group represented by formula (G14) (R^{e} is a benzene group, and L is a linking group (e.g., a carbonyl group) containing a heteroatom).

### (Structural Unit Represented by Formula (XA))

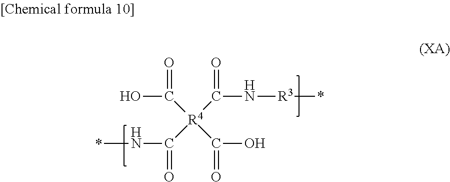

In the formula, R³ and R⁴ each independently represent an organic group, and at least one of R³ and R⁴ is a hydrocarbon group (X).

Examples of the organic group include the hydrocarbon group (X) and the organic group (Y).

According to one or more embodiments, in a structural unit represented by formula (XA), for example, R³ is the hydrocarbon group (X), and R⁴ is the organic group (Y). Preferably, R³ is a group selected from the group consisting of: a group represented by formula (G2); a group represented by formula (G3); a group represented by formula (G4); a group represented by formula (G5); and a group represented by formula (G6), and R⁴ is a group selected from the group consisting of: a group represented by formula (G12); a group represented by formula (G13); and a group represented by formula (G14). More preferably, R³ is a group selected from the group consisting of: a group represented by formula (G4); a group represented by formula (G7); a group represented by formula (G8); and a group represented by formula (G9), and R⁴ is a group represented by formula (G14). Even more preferably, R³ is a group represented by formula (G8), and R⁴ is represented by formula (G14) where R^{e} is a benzene group.

According to one or more embodiments, in a structural unit represented by formula (XA), for example, R³ is a group selected from the group consisting of: a group represented by formula (G2); a group represented by formula (G3); a group represented by formula (G4); a group represented by formula (G5); and a group represented by formula (G6), and R⁴ is a group selected from the group consisting of: a group represented by formula (G12); a group represented by formula (G13); and a group represented by formula (G14). Preferably, R³ is a group selected from the group consisting of: a group represented by formula (G4); a group represented by formula (G7); a group represented by formula (G8); and a group represented by formula (G9), and R⁴ is a group selected from the group consisting of a group represented by formula (G12) and a group represented by formula (G14). For example, a structural unit represented by formula (XA) includes a structural unit where R³ is a group represented by formula (G8), and R⁴ is a group represented by formula (G12) (R^{e} is a benzene group). For example, a structural unit represented by formula (XA) includes a structural unit where R³ is a group represented by formula (G8), and R⁴ is a group represented by formula (G14) (R^{e} is a benzene group, and L is a single bond).

### (Structural Unit Represented by Formula (YI))

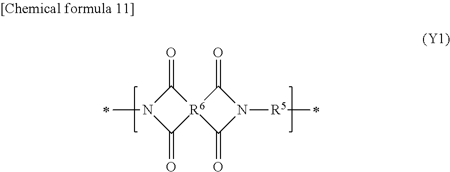

In the formula, R⁵ and R⁶ each independently represent an organic group (Y).

According to one or more embodiments, in a structural unit represented by formula (YI), for example, R⁵ is a group selected from the group consisting of: a group represented by formula (G16); a group represented by formula (G17); and a group represented by formula (G18), and R⁶ is a group selected from the group consisting of: a group represented by formula (G12); a group represented by formula (G13); and a group represented by formula (G14). Preferably, R⁵ is a group represented by formula (G16) or a group represented by formula (G18), and R⁶ is a group represented by formula (G12) or a group represented by formula (G14). More preferably, R⁵ is a group represented by formula (G16) where R^{e} is a benzene group, or a group represented by formula (18) where R^{e} is a benzene group, and R⁶ is a group represented by formula (G12) where R^{e} is a benzene group, or a group represented by formula (14) where R^{e} is a benzene group.

According to one or more embodiments, in a structural unit represented by formula (YI), for example, R⁵ is a group selected from the group consisting of: a group represented by formula (G16); a group represented by formula (G17); a group represented by formula (G18); a group represented by formula (G18a); and a group represented by formula (G18b), and R⁶ is a group selected from the group consisting of: a group represented by formula (G12); a group represented by formula (G13); and a group represented by formula (G14). Preferably, R⁵ is a group selected from the group consisting of: a group represented by formula (G16); a group represented by formula (G18); and a group represented by formula (G18b), and R⁶ is a group represented by formula (G12) or a group represented by formula (G14). More preferably, R⁵ is a group represented by formula (G18), and R⁶ is a group represented by formula (12). For example, a structural unit represented by formula (YI) includes a structural unit where R⁵ is a group represented by formula (G18) (R^{e} is a benzene group, and L is a group (e.g., an oxy group) containing a heteroatom), and R⁶ is a group represented by formula (12) (R^{e} is a benzene group).

### (Structural Unit Represented by Formula (YA))

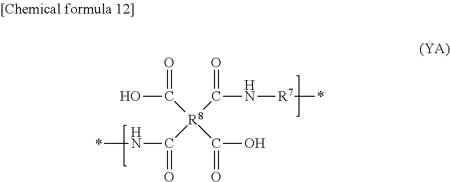

In the formula, R⁷ and R⁸ each independently represent an organic group (Y).

According to one or more embodiments, in a structural unit represented by formula (YA), for example, R⁷ is a group selected from the group consisting of: a group represented by formula (G16); a group represented by formula (G17); and a group represented by formula (G18), and R⁸ is a group selected from the group consisting of: a group represented by formula (G12); a group represented by formula (G13); and a group represented by formula (G14). Preferably, R⁷ is a group represented by formula (G16) or a group represented by formula (G18), and R⁸ is a group represented by formula (G12) or a group represented by formula (G14). More preferably, R⁷ is a group represented by formula (G16) where R^{e} is a benzene group, or a group represented by formula (18) where R^{e} is a benzene group, and R⁸ is a group represented by formula (G12) where R^{e} is a benzene group, or a group represented by formula (14) where R^{e} is a benzene group.

According to one or more embodiments, in a structural unit represented by formula (YA), for example, R⁷ is a group selected from the group consisting of: a group represented by formula (G16); a group represented by formula (G17); a group represented by formula (G18); a group represented by formula (G18a); and a group represented by formula (G18b), and R⁸ is a group selected from the group consisting of: a group represented by formula (G12); a group represented by formula (G13); and a group represented by formula (G14). Preferably, R⁷ is a group selected from the group consisting of: a group represented by formula (G16); a group represented by formula (G18); and a group represented by formula (G18b), and R⁶ is a group represented by formula (G12) or a group represented by formula (G14). More preferably, R⁷ is a group represented by formula (16) or a group represented by formula (18b), and R⁸ is a group represented by formula (14). For example, a structural unit represented by formula (YA) includes a structural unit where R⁷ is a group represented by formula (16) (R^{e} is a benzene group), and R⁸ is a group represented by formula (G14) (R^{e} is a benzene group, and L is a single bond). For example, a structural unit represented by formula (YA) includes a structural unit where R⁷ is a group represented by formula (18b) (R^{e} is a benzene group, and L is each independently a single bond or a group (e.g., an oxy group) containing a heteroatom), and R⁸ is a group represented by formula (G14) (R^{e} is a benzene group, and L is a single bond).

### (Content Percentage)

The polyimide block (BI) preferably includes a structural unit represented by formula (XI), and more preferably includes a structural unit represented by formula (XI) where the hydrocarbon group (X) includes a saturated alicyclic hydrocarbon group.

In the polyimide block (BI), the content of the hydrocarbon group (X) relative to the total mass of R¹ to R⁸ is preferably within a range from 0% to 70% by mass, from 10% to 60% by mass, or from 20% to 50% by mass. In particular, when the content of the hydrocarbon group (X) is 20% by mass or more, a polyimide having a low permittivity and a low dielectric loss tangent is easily obtained. In the polyimide block (BI), the content of the organic group (Y) relative to the total mass of R¹ to R⁸ is preferably within a range from 0% to 60% by mass, from 2% to 50% by mass, or from 4% to 40% by mass. In particular, when the content of the organic group (Y) including at least one of an aromatic hydrocarbon group and an aromatic heterocyclic compound group is 4% by mass or more, a polyimide having good mechanical strength and good heat resistance is easily obtained. In the present disclosure, depending on a structure included in a block or a polymer, the mass of one or more of R¹ to R⁸ in the “total mass of R¹ to R⁸” may be 0.

The polyamic acid block (BA) preferably includes a structural unit represented by formula (YA), and more preferably a structural unit represented by formula (YA) where the organic group (Y) includes an aromatic hydrocarbon group.

In the polyamic acid block (BA), the content of the hydrocarbon group (X) relative to the total mass of R¹ to R⁸ is preferably within a range from 0% to 80% by mass, from 0% to 50% by mass, or from 0% to 30% by mass. In the polyamic acid block (BA), the content of the organic group (Y) relative to the total mass of R¹ to R⁸ is preferably within a range from 20% to 100% by mass, from 30% to 80% by mass, or from 40% to 60% by mass. In particular, when the content of the organic group (Y) including at least one of an aromatic hydrocarbon group and an aromatic heterocyclic compound group is 40% by mass or more, a polyimide having good mechanical strength and good heat resistance is easily obtained.

In the block copolymer, the content of the hydrocarbon group (X) relative to the total mass of R¹ to R⁸ is preferably within a range from 5% to 70% by mass, from 10% to 60% by mass, or from 20% to 50% by mass. From the viewpoint of lowering the permittivity and dielectric loss tangent, the content of the hydrocarbon group (X) is preferably high. In particular, when the content of the hydrocarbon group (X) is 10% by mass or more, a polyimide having a low permittivity and a low dielectric loss tangent is easily obtained.

In the block copolymer, the content of the organic group (Y) relative to the total mass of R¹ to R⁸ is preferably within a range from 30% to 95% by mass, from 40% to 90% by mass, or from 50% to 80% by mass. From the viewpoint of obtaining good mechanical strength and good heat resistance, the organic group (Y) preferably includes at least one of an aromatic hydrocarbon group and an aromatic heterocyclic compound group, and the content of the organic group (Y) is preferably high. In particular, when the content of the organic group (Y) including at least one of an aromatic hydrocarbon group and an aromatic heterocyclic compound group is 50% by mass or more, a polyimide having good mechanical strength and good heat resistance is easily obtained.

### (Optional Structural Unit)

The block copolymer may further include another optional structural unit in addition to the structural unit represented by formula (YI) and the structural unit represented by formula (YA). In the block copolymer, the content of the other optional structural unit relative to the total mass of all the structural units included in the block copolymer is within a range from 0% to 10% by mass, or from 0% to 5% by mass, for example. As the other optional structural unit, an optional structural unit can be included such as: a structural unit including a structure derived from a trifunctional or higher polyamine, or a structure derived from a trifunctional or higher polyisocyanate; a structural unit having an amide linkage (also referred to as an amide group); a structural unit having an imide group and an amide group; and a structural unit having an amic acid group and an amide group. These optional structural units may or may not include the hydrocarbon group (X).

[Block Copolymer Including Structure Derived from Diamine or Diisocyanate and Structure Derived from Tetracarboxylic Dianhydride]

In one or more embodiments of the present invention, the block copolymer includes a polyimide block (BI) and a polyamic acid block (BA), and includes a structure derived from a diamine or diisocyanate and a structure derived from a tetracarboxylic dianhydride, where at least one of the structure derived from a diamine or diisocyanate and the structure derived from a tetracarboxylic dianhydride includes a structure having a hydrocarbon group (X). Examples of the structure having a hydrocarbon group (X) include a structure derived from a diamine or diisocyanate having a hydrocarbon group (X) and a structure derived from a tetracarboxylic dianhydride having a hydrocarbon group (X). In the present disclosure, “diamine or diisocyanate” means “at least one compound selected from the group consisting of a diamine and a diisocyanate”.

In a preferred embodiment, at least the structure derived from a diamine or diisocyanate includes a structure derived from a diamine or diisocyanate having a hydrocarbon group (X). The structure derived from a tetracarboxylic dianhydride may include a structure derived from a tetracarboxylic dianhydride having a hydrocarbon group (X).

In a preferred embodiment, at least the structure derived from a tetracarboxylic dianhydride includes a structure derived from a tetracarboxylic dianhydride having an organic group (Y). The structure derived from a diamine or diisocyanate may include a structure derived from a diamine or diisocyanate having an organic group (Y).

In the present disclosure, a structural unit may be referred to as “structural unit (Xd)” that has a structure derived from a diamine or diisocyanate and a structure derived from a tetracarboxylic dianhydride, where at least one of the structure derived from a diamine or diisocyanate and the structure derived from a tetracarboxylic dianhydride includes a structure having a hydrocarbon group (X).

### (Diamine Having Hydrocarbon Group (X))

A diamine having a hydrocarbon group (X) can be represented by formula (Ax) below, for example.

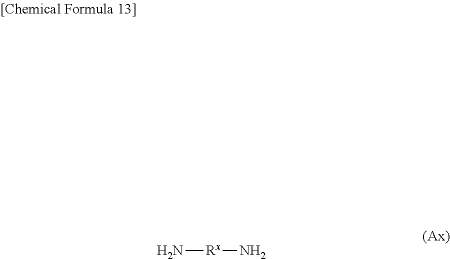

In the formula, R^{x} represents a hydrocarbon group (X). Examples of R^{x} include the group represented by formula (G2) above to the group represented by formula (G9) above.

Specific examples of the diamine having a hydrocarbon group (X) include the following.

Diamines which have a saturated aliphatic hydrocarbon group and where the number of carbon atoms is nine or more, such as 1,9-diaminononane, 1,10-diaminodecane, 1,11-diaminoundecane, 1,12-diaminododecane, 1,14-diaminotetradecane, and 1,16-diaminohexadecane;

Diamines which have an unsaturated aliphatic hydrocarbon group and where the number of carbon atoms is nine or more, such as 1,9-diaminononene, 1,10-diaminodecene, 1,11-diaminoundecene, 1,12-diaminododecene, 1,14-diaminotetradecene, and 1,16-diaminohexadecene;

Diamines which have a saturated alicyclic hydrocarbon group and where the number of carbon atoms is nine or more, such as isophoronediamine, bis(aminomethyl)norbornane, 1,3-diaminoadamantane, and 4,4′-diaminodicyclohexylmethane;

Diamines which have an unsaturated alicyclic hydrocarbon group and where the number of carbon atoms is nine or more, such as bis(aminomethyl)norbornene, and 4,4′-diaminodicyclohexenylmethane; and

Dimer diamines where the diamine is a compound in which the number of carbon atoms is nine or more including: diamines derived from dimers (also referred to as dimer acid) of unsaturated fatty acids, such as: monounsaturated fatty acids, such as crotonic acid, myristoleic acid, palmitoleic acid, sapienoic acid, oleic acid, elaidic acid, vaccenic acid, gadoleic acid, eicosenoic acid, erucic acid, and nervonic acid; diunsaturated fatty acids, such as linoleic acid, eicosadienoic acid, and docosadienoic acid; and triunsaturated fatty acids, such as linolenic acid, pinolenic acid, eleostearic acid, mead acid, dihomo-γ-linolenic acid, and eicosatrienoic acid; and diamines where a carbon-carbon double bond in a molecule of these diamines are hydrogenated

Examples of commercial products of dimer diamines where the number of carbon atoms is nine or more include “PRIAMINE1075” and “PRIAMINE1074” manufactured by Croda Japan K.K.

### (Diamines Having Organic Group (Y))

A diamine having an organic group (Y) can be represented, for example, by formula (Ay) below.

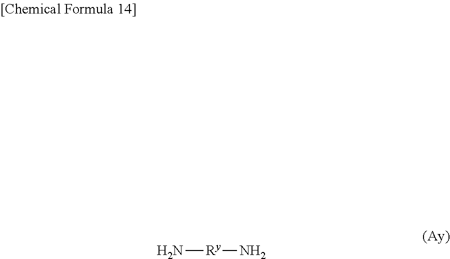

In the formula, R^{y} represents an organic group (Y). Examples of R^{y} include the group represented by formula (G16) above to the group represented by formula (G18) above, the group represented by formula (G18a) above, and the group represented by formula (G18b) above.

Specific examples of diamines having an organic group (Y) include the following.

Diamines which have a saturated aliphatic hydrocarbon group and where the number of carbon atoms is eight or less, such as 1,2-ethylenediamine, 1,2-diaminopropane, 1,3-diaminopropane, 1,4-diaminobutane, 1,5-diaminopentane, and 1,6-diaminohexane;

Diamines which have a saturated aliphatic hydrocarbon group and where the number of carbon atoms is eight or less, such as 1,4-diaminocyclohexane, 1,3-bis(aminomethyl)cyclohexane, and 1,4-bis(aminomethyl)cyclohexane; and

Diamines which have an aromatic hydrocarbon group and where the number of carbon atoms is eight or less, such as 1,4-phenylenediamine, 4,4′-diaminodiphenyl ether, 4,4′-diamino-3,3′-dimethyldiphenyl ether, 4,4′-diaminodiphenylmethane, 4,4′-diaminodiphenylpropane, 1,4-bis(4-aminophenoxy)benzene, 2,2-bis(4-(4-aminophenoxy)phenyl)propane, and 4,4′-bis(4-aminophenoxy)biphenyl

### (Diisocyanate Having Hydrocarbon Group (X))

A diisocyanate having a hydrocarbon group (X) can be represented by formula (Ix) below, for example.

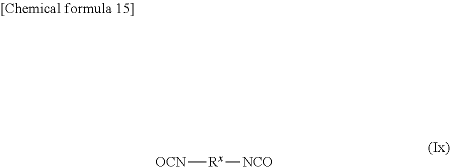

In the formula, R^{x} represents a hydrocarbon group (X). Examples of R^{x} include the group represented by formula (G2) above to the group represented by formula (G9) above.

Specific examples of the diisocyanates having a hydrocarbon group (X) include compounds having the same structures as the compounds described as specific examples of the above diamine except that an amino group is replaced with an isocyanate group.

### (Diisocyanate Having Organic Group (Y))

The diisocyanate having an organic group (Y) can be represented by formula (Iy) below, for example.

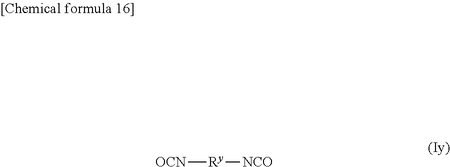

In the formula, R^{y} represents an organic group (Y). Examples of R^{y} include the group represented by formula (G16) above to the group represented by formula (G18) above, the group represented by formula (G18a) above, and the group represented by formula (G18b) above.

Specific examples of the diisocyanate having an organic group (Y) include compounds having the same structures as the compounds described as specific examples of the above diamine except that an amino group is replaced with an isocyanate group.

### (Tetracarboxylic Dianhydride Having Hydrocarbon Group (X))

A tetracarboxylic dianhydride having a hydrocarbon group (X) can be represented by formula (Cx) below, for example.

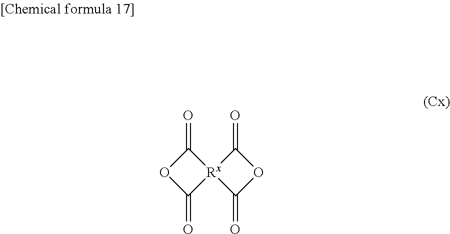

In the formula, R^{x} represents a hydrocarbon group (X). Preferred examples of the hydrocarbon group (X) are as described above.

Specific examples of the tetracarboxylic dianhydride having a hydrocarbon group (X) include the following. “Number of carbon atoms” below is the number of carbon atoms in the hydrocarbon group (X), and “number of carbon atoms” below does not include the number of carbon atoms included in a carboxylic acid anhydride group.

Tetracarboxylic dianhydrides which have an alicyclic hydrocarbon group and where the number of carbon atoms is nine or more, such as 3,3′,4,4′-bicyclohexyltetracarboxylic dianhydride, and 2,2-bis(3,4-dicarboxycyclohexyl)propane dianhydride

### (Tetracarboxylic Dianhydride Having Organic Group (Y))

A tetracarboxylic dianhydride having an organic group (Y) can be represented by formula (Cy) below, for example.

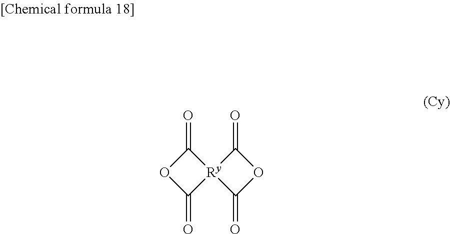

In the formula, R^{y} represents an organic group (Y). Examples of R^{y} include the group represented by formula (G12) above to the group represented by formula (G14) above.

Specific examples of the tetracarboxylic dianhydride having an organic group (Y) include the following. “Number of carbon atoms” below is the number of carbon atoms in the non-aromatic hydrocarbon group included in the organic group (Y), and “number of carbon atoms” below does not include the number of carbon atoms included in an aromatic ring and a carboxylic anhydride group.

Tetracarboxylic dianhydrides which have a saturated aliphatic hydrocarbon group and where the number of carbon atoms is eight or less, such as 1,2,3,4-butane tetracarboxylic dianhydride, and 1,2,5,6-hexane tetracarboxylic dianhydride;

Tetracarboxylic dianhydrides which have a saturated alicyclic hydrocarbon group and where the number of carbon atoms is eight or less, such as 1,2,3,4-cyclobutane tetracarboxylic dianhydride and 1,2,4,5-cyclohexane tetracarboxylic dianhydride;

Tetracarboxylic dianhydrides which have an aromatic hydrocarbon group and where the number of carbon atoms is eight or less, such as pyromellitic dianhydride, bis(2,3-dicarboxyphenyl)methane dianhydride, bis(3,4-dicarboxyphenyl)methane dianhydride, 3,3′,4,4′-biphenyltetracarboxylic dianhydride, 3,3′,4,4′-benzophenone tetracarboxylic dianhydride, 4,4′-oxydiphthalic anhydride, and 3,4′-oxydiphthalic anhydride; and

Tetracarboxylic dianhydrides which have an aromatic heterocyclic compound group and where the number of carbon atoms is eight or less, such as pyridine tetracarboxylic dianhydride and thiophene tetracarboxylic dianhydride

The structure derived from a diamine or diisocyanate preferably includes a structure derived from a diamine or diisocyanate having a hydrocarbon group (X), more preferably includes at least one selected from the group consisting of: a structure derived from a diamine which has a saturated aliphatic hydrocarbon group and where the number of carbon atoms is nine or more; a structure derived from a diamine which has an unsaturated aliphatic hydrocarbon group and where the number of carbon atoms is nine or more; a structure derived from a diamine which has a saturated alicyclic hydrocarbon group and where the number of carbon atoms is nine or more; a structure derived from a diamine which has an unsaturated alicyclic hydrocarbon group and where the number of carbon atoms is nine or more; and a structure derived from a dimer diamine where the number of carbon atoms is nine or more, and even more preferably includes a structure derived from a dimer diamine where the number of carbon atoms is nine or more.

The structure derived from a diamine or diisocyanate preferably includes a structure derived from a diamine or diisocyanate having a hydrocarbon group (X), and more preferably includes a structure derived from a diamine or diisocyanate having a hydrocarbon group (X), and a structure derived from a diamine or diisocyanate, having an aromatic hydrocarbon group.

In the block copolymer, for example, the structure derived from a diamine or diisocyanate included in the polyamic acid block (BA) includes a structure derived from a diamine or diisocyanate having an aromatic hydrocarbon group.

The structure derived from a tetracarboxylic dianhydride preferably includes a structure derived from a tetracarboxylic dianhydride having an organic group (Y); more preferably includes a structure derived from a tetracarboxylic dianhydride having an aromatic hydrocarbon group; and even more preferably includes at least one selected from the group consisting of a structure derived from a pyromellitic dianhydride and a structure derived from 3,3′,4,4′-biphenyltetracarboxylic dianhydride.

### (Content Percentage)

In the polyimide block (BI), the content of the structure having a hydrocarbon group (X) is, for example, within a range from 0% to 95% by mass, and preferably from 40% to 95% by mass, 50% to 95% by mass, or 70% to 90% by mass, relative to the total mass of the structure derived from a diamine or diisocyanate and the structure derived from a tetracarboxylic dianhydride. In particular, when the content of the structure having a hydrocarbon group (X) is 70% by mass or more, a polyimide having a low permittivity and a low dielectric loss tangent is easily obtained. In the polyimide block (BI), the content of the structure having an organic group (Y) is, for example, within a range from 5% to 100% by mass, and preferably from 5% to 60% by mass, 5% to 50% by mass, or 10% to 30% by mass, relative to the total mass of the structure derived from a diamine or diisocyanate and the structure derived from a tetracarboxylic dianhydride. In particular, when the content of the structure having an organic group (Y) including at least one of an aromatic hydrocarbon group and an aromatic heterocyclic compound group is 10% by mass or more, a polyimide having good mechanical strength and good heat resistance is easily obtained.

In the polyamic acid block (BA), the content of the structure having an hydrocarbon group (X) is preferably within a range from 0% to 60% by mass, 10% to 50% by mass, or 20% to 40% by mass, relative to the total mass of the structure derived from a diamine or diisocyanate and the structure derived from a tetracarboxylic dianhydride. In particular, when the content of the structure having a hydrocarbon group (X) is 10% by mass or more, a polyimide having a low permittivity and a low dielectric loss tangent is easily obtained. In the polyamic acid block (BA), the content of the structure having an organic group (Y) is preferably within a range from 30% to 100% by mass, 50% to 95% by mass, or 70% to 90% by mass, relative to the total mass of the structure derived from a diamine or diisocyanate and the structure derived from a tetracarboxylic dianhydride. In particular, when the content of the structure including at least one of an aromatic hydrocarbon group and an aromatic heterocyclic compound group and having an organic group (Y) is 70% by mass or more, a polyimide having good mechanical strength and good heat resistance is easily obtained.

In the block copolymer, the content of the structure having a hydrocarbon group (X) is preferably within a range from 3% to 60% by mass, 5% to 50% by mass, or 10% to 40% by mass, relative to the total mass of the structure derived from a diamine or diisocyanate and the structure derived from a tetracarboxylic dianhydride. From the viewpoint of lowering the permittivity and dielectric loss tangent, the content of the structure having a hydrocarbon group (X) is preferably high. In particular, when the content of the structure having a hydrocarbon group (X) is 5% by mass or more, a polyimide having a low permittivity and a low dielectric loss tangent is easily obtained.

In the block copolymer, the content of the structure having an organic group (Y) is preferably within a range from 40% to 97% by mass, 50% to 95% by mass, or 60% to 90% by mass, relative to the total mass of the structure derived from a diamine or diisocyanate and the structure derived from a tetracarboxylic dianhydride. From the viewpoint of obtaining good mechanical strength and good heat resistance, the organic group (Y) preferably includes at least one of an aromatic hydrocarbon group and an aromatic heterocyclic compound group, and the content of the structure having such an organic group (Y) is preferably high. In particular, when the content of the structure having an organic group (Y) including at least one of an aromatic hydrocarbon group and an aromatic heterocyclic compound group is 50% by mass or more, a polyimide having good mechanical strength and good heat resistance is easily obtained.

### (Optional Structure)

In addition to the structure derived from a diamine or diisocyanate and a structure derived from a tetracarboxylic dianhydride, the block copolymer may further include another optional structure. In the block copolymer, the content of the other optional structural unit is within a range from 0% to 10% by mass or 0% to 5% by mass, relative to the total mass of all the structures included in the block copolymer, for example. As the other optional structure, an optional structure can be included, such as a structure derived from a trifunctional or higher polyamine or polyisocyanate, a structure derived from a dicarboxylic acid compound, and a structure derived from a tricarboxylic acid compound. These optional structures may or may not include the hydrocarbon group (X).

### [Block Copolymer Obtained by Using Diamine or Diisocyanate and Tetracarboxylic Dianhydride]

In one or more embodiments of the present invention, the block copolymer is obtained by using: a polyimide (PI) that is obtained by using a diamine or diisocyanate and a tetracarboxylic dianhydride; and a polyamic acid (PA) that is obtained by using a diamine and a tetracarboxylic dianhydride, where at least one selected from the group consisting of: the diamine or diisocyanate and the tetracarboxylic dianhydride, which are used to obtain the polyimide (PI); and the diamine and the tetracarboxylic dianhydride, which are used to obtain the polyamic acid (PA), has a hydrocarbon group (X). Methods for obtaining the polyimide (PI), the polyamic acid (PA), and the block copolymer will be described below.

### [Polyimide Block (BI)]

Since the block copolymer has the polyimide block (BI), occurrences of an exchange reaction and crosslink formation can be prevented when obtaining the block copolymer or when cyclizing the amic acid groups.

In the present disclosure, in the polyimide block (BI), the content of the imide group relative to the total of the imide group and the amic acid group is, for example, more than 50% by mole, 80% by mole or more, or 90% by mole or more. The upper limit of the content of the imide group may be 100% by mole. In the present disclosure, the content can be measured using Fourier transform infrared spectroscopy (FTIR).

The polyimide block (BI) may or may not include the structural unit (X). In the block copolymer, when the polyimide block (BI) does not include the structural unit (X), the polyimide block (BI) includes the structural unit (Y). In the block copolymer, when the polyimide block (BI) does not include the structural unit (X), the polyamic acid block (BA) includes the structural unit (X).

The number average molecular weight of the polyimide block (BI) is, for example, 500 or more, 1,000 or more, 2,000 or more, or 3,000 or more. The number average molecular weight of the polyimide block (BI) is, for example, 10,000 or less, 8,000 or less, 7,000 or less, or 5,000 or less. When the number average molecular weight is 500 or more, a polyimide having a low expansion coefficient tends to be easily obtained. When the number average molecular weight is 10,000 or less, solubility of the block copolymer in a solvent tends to be easily ensured. The number average molecular weight of the polyimide block (BI) is, for example, within a range from 500 to 10,000, from 1,000 to 8,000, from 2,000 to 7,000, or from 3,000 to 5,000. In the present disclosure, the number average molecular weight can be measured with gel permeation chromatography (GPC) using a standard polystyrene calibration curve. Specifically, it can be determined using a method described in examples.

The polyimide block (BI) may be a linear block or a branched block, preferably a linear block.

### [Polyamic Acid Block (BA)]

Since the block copolymer includes the polyamic acid block, good solubility in a solvent tends to be easily obtained.

In the present disclosure, in the polyamic acid block (BA), the content of the amic acid group relative to the total of the imide group and the amic acid group is, for example, more than 50% by mole, 80% by mole or more, or 90% by mole or more. The upper limit of the content of the amic acid group may be 100% by mole. The content can be measured using FTIR.

The polyamic acid block (BA) may or may not include the structural unit (X). In the block copolymer, when the polyamic acid block (BA) does not include the structural unit (X), the polyamic acid block (BA) includes the structural unit (Y). In a block copolymer, when the polyamic acid block (BA) does not include the structural unit (X), the polyimide block (BI) includes the structural unit (X).

The number average molecular weight of the polyamic acid block (BA) is, for example, 500 or more, 1,000 or more, 3,000 or more, or 6,000 or more. The number average molecular weight of the polyamic acid block (BA) is, for example, 30,000 or less, 25,000 or less, 20,000 or less, or 10,000 or less. When the number average molecular weight is 500 or more, excellent film forming properties tend to be easily obtained. When the number average molecular weight is 30,000 or less, a composition including the block copolymer and a solvent tends to be easily adjusted to have a viscosity suitable for applying. The number average molecular weight of the polyamic acid block (BA) is, for example, within a range from 500 to 30,000, from 1,000 to 25,000, from 3,000 to 20,000, or from 6,000 to 10,000.

The polyamic acid block (BA) may be a linear block or a branched block, preferably a linear block.

### [Molecular Weight of Block Copolymer, Content of Structural Unit (X)]

Since the block copolymer includes the polyimide block (BI) and the polyamic acid block (BA), a polyimide having a low coefficient of thermal expansion tends to be easily obtained. It is thought that polyimide molecules are easily oriented by having a block structure.

In the block copolymer, only one of the polyimide block (BI) and the polyamic acid block (BA) includes the hydrocarbon group (X), or both of the polyimide block (BI) and the polyamic acid block (BA) include the hydrocarbon group (X). The polyimide block (BI) and the polyamic acid block (BA) may each independently include one type, or two or more types of hydrocarbon group (X).

The number average molecular weight of the block copolymer is, for example, 5,000 or more, 10,000 or more, 20,000 or more, or 30,000 or more. The number average molecular weight of the block copolymer is, for example, 100,000 or less, 80,000 or less, 70,000 or less, or 60,000 or less. When the number average molecular weight is 5,000 or more, excellent film forming properties tend to be easily obtained. When the number average molecular weight is 100,000 or less, a composition including the block copolymer and a solvent tends to be easily adjusted to have a viscosity suitable for applying. The number average molecular weight of the block copolymer is, for example, within a range from 5,000 to 100,000, from 10,000 to 80,000, from 20,000 to 70,000, or from 30,000 to 60,000.

The content of the polyimide block (BI) in the block copolymer is more than 0% by mass and less than 100% by mass relative to the mass of the block copolymer. The content of the polyimide block (BI) is, for example, more than 0% by mass, 30% by mass or more, 60% by mass or more, or 90% by mass or more. The content of the polyimide block (BI) is, for example, less than 100% by mass, 70% by mass or less, 40% by mass or less, or 10% by mass or less. The content of the polyimide block (BI) is, for example, more than 0% by mass and 70% by mass or less, more than 0% by mass and 40% by mass or less, 30% by mass or more and less than 100% by mass, or 60% by mass or more and less than 100% by mass. The content of the polyimide block (BI) may be, for example, within a range from 10% to 60% by mass, or from 20% to 50% by mass.

The content of the polyamic acid block (BA) in the block copolymer is more than 0% by mass and less than 100% by mass relative to the mass of the block copolymer. The content of the polyamic acid block (BA) is, for example, more than 0% by mass, 30% by mass or more, 60% by mass or more, or 90% by mass or more. The content of the polyamic acid block (BA) is, for example, less than 100% by mass, 70% by mass or less, 40% by mass or less, or 10% by mass or less. The content of the polyamic acid block (BA) is, for example, more than 0% by mass and 70% by mass or less, more than 0% by mass and 40% by mass or less, 30% by mass or more and less than 100% by mass, or 60% by mass or more and less than 100% by mass. The content of the polyimide block (BI) may be, for example, within a range from 40% to 90% by mass, or from 50% to 80% by mass.

The higher the content of the polyimide block (BI), the more it is possible to prevent occurrences of an exchange reaction and crosslink formation when obtaining the block copolymer or cyclizing an amic acid group. In contrast, the higher the content of the polyamic acid block (BA), the more easily the block copolymer dissolves in an organic solvent.

In the block copolymer, for example, the number average molecular weight of the polyimide block (BI) is smaller than the number average molecular weight of the polyamic acid block (BA). Preferably, the block copolymer includes the polyimide block (BI) and the polyamic acid block (BA) having a number average molecular weight larger than that of the polyimide block (BI). When the number average molecular weight of the polyimide block (BI) is smaller than that of the polyamic acid block (BA), it tends to be easier to synthesize the block copolymer and to ensure the solubility of the block copolymer. Since the polyamic acid block (BA) having a number average molecular weight larger than that of the polyimide block (BI) is included, the block copolymer having a sufficient number average molecular weight tends to be easily synthesized.

It is preferable for the block copolymer that a polyimide obtained by using the block copolymer satisfy at least one of a relative permittivity, a dielectric loss tangent, a coefficient of thermal expansion, and a water absorption percentage that will be described below. It is particularly preferable for the block copolymer that a polyimide obtained by using the block copolymer satisfy at least one of a relative permittivity, a dielectric loss tangent, and a coefficient of thermal expansion that will be described below.

### [Applications]

In one or more embodiments of the present invention, a polyimide having a low permittivity, a low dielectric loss tangent, and a low coefficient of thermal expansion can be obtained by using the block copolymer. The obtained polyimide can be used in various electronic components and mechanical components, for example, displays, solar cells, touch panels, organic EL lighting, millimeter wave radars, high-frequency antennas, substrates for high-speed transmission, and the like. Among these, the obtained polyimide can be preferably used for equipment used in high-frequency regions, for example, millimeter wave radars, high-frequency antennas, substrates for high-speed transmission, and the like. Millimeter wave radars are a radar that detects an object by transmitting millimeter waves to the object and receiving reflected waves from the object, and vehicle-mounted millimeter wave radars are applied to a collision prevention system, an automatic driving system, and the like. For high-frequency antennas, there is a demand for high-frequency and high-speed transmission for high-speed communication in communication equipment, etc., and a material having a lower permittivity and a lower dielectric loss tangent is desired when a high-frequency antenna is accommodated in a housing of small-sized communication equipment, etc. Examples of high-speed transmission substrates include high-speed transmission cables and high-speed transmission connectors.

### <Method for Producing Block Copolymer>

In one or more embodiments of the present invention, a method for producing a block copolymer includes: obtaining a polyimide (PI) by using a diamine or diisocyanate and a tetracarboxylic dianhydride; obtaining a polyamic acid (PA) by using a diamine and a tetracarboxylic dianhydride; and obtaining a block copolymer by using the polyimide (PI) and the polyamic acid (PA), where at least one selected from the group consisting of the diamine or diisocyanate and the tetracarboxylic dianhydride, which are used to obtain the polyimide (PI); and the diamine and the tetracarboxylic dianhydride, which are used to obtain the polyamic acid (PA), has a hydrocarbon group (X). According to this production method, the block copolymer of the above embodiments can be easily produced.

For synthesizing the polyimide (PI) and the polyamic acid (PA), monomers can be used, such as a diamine, a diisocyanate, a tetracarboxylic dianhydride, a polyamine, a polyisocyanate, a dicarboxylic acid compound, and a tricarboxylic acid compound described above.

A monomer reaction can be performed through solution polymerization. Examples of a solvent used during the reaction include: polar solvents, such as N-methyl-2 pyrrolidone (NMP), N-ethyl-2-pyrrolidone (NEP), γ-butyrolactone (GBL), 3-methoxy-N, N-dimethylpropanamide (MPA), N,N′-dimethylformamide, N,N′-dimethylpropylurea[1,3-dimethyl-3,4,5,6-tetrahydropyridimine-2(1H)-one], dimethyl sulfoxide, diethylene glycol dimethyl ether, triethylene glycol dimethyl ether, and sulfolane; aromatic hydrocarbon solvents, such as xylene and toluene; and ketone-based solvents, such as methyl ethyl ketone and methyl isobutyl ketone. The solvent preferably includes at least one selected from the group consisting of N-methyl-2-pyrrolidone (NMP), N-ethyl-2-pyrrolidone (NEP), γ-butyrolactone (GBL), and 3-methoxy-N,N-dimethylpropanamide (MPA), and more preferably includes at least one selected from the group consisting of N-methyl-2-pyrrolidone (NMP), γ-butyrolactone (GBL), and 3-methoxy-N,N-dimethylpropanamide (MPA).

The amount of the solvent used is preferably within a range from 100 to 600 parts by mass, and more preferably from 200 to 400 parts by mass, relative to 100 parts by mass of the total amount of monomers. When the amount of the solvent used is 100 parts by mass or more, respective monomers can be reacted homogeneously. When the amount of the solvent used is 600 parts by mass or less, a polymerization reaction can be promoted. When the amount of the solvent used is small, a polyimide (PI) or polyamic acid (PA) containing liquid can be obtained that includes the polyimide (PI) or the polyamic acid (PA) at a high concentration.

A reaction temperature when the polyamic acid is synthesized using the monomers is not particularly limited. The reaction temperature may be, for example, within a range from 10 to 50° C., or from 20° C. to 40° C. Reaction time may be, for example, within a range from 30 minutes to 24 hours, from 1 to 12 hours, or from 3 to 6 hours. The reaction time can be adjusted so as to obtain an expected reaction product by sampling a reaction product and measuring the number average molecular weight, concentration of a residual amino group or an isocyanate group, and the like.

A temperature where the polyimide is obtained using the polyamic acid (i.e., when imidization is performed) is not particularly limited. Imidization temperature may be, for example, within a range from 120° C. to 200° C., or from 160° C. to 180° C. Reaction time may be, for example, within a range from 30 minutes to 24 hours, from 1 to 12 hours, or from 3 to 6 hours. The reaction time can be adjusted so as to obtain an expected reaction product by sampling a reaction product and measuring the number average molecular weight, concentration of a residual amic acid group, and the like.

Since synthesis is easy, it is preferable that a terminal of the polymer chain of the polyimide (PI) be a carboxylic acid anhydride group, and a terminal of the polymer chain of the polyamic acid (PA) be an amino group. In a ratio between the diamine or diisocyanate and the tetracarboxylic dianhydride, which are used to obtain the polyimide (PI), the tetracarboxylic dianhydride is, for example, more than 1.00% by mole, 1.05% by mole or more, or 1.10% by mole or more, relative to the diamine or diisocyanate. In a ratio between the diamine and the tetracarboxylic dianhydride, which are used to obtain the polyamic acid (PA), the tetracarboxylic dianhydride is, for example, less than 1.00% by mole, 0.98% by mole or less, or 0.97% by mole or less, relative to the diamine.

The block copolymer is synthesized by using the polyimide (PI) and the polyamic acid (PA). An optional polymer may be further used for the synthesis.

A reaction between the polyimide (PI) and the polyamic acid (PA) can be performed through solution polymerization. The solvents described above can be used as the solvent during the reaction.

A reaction temperature is not particularly limited. The reaction temperature may be, for example, within a range from 20 to 100° C., from 30° C. to 80° C., or from 40° C. to 70°, from the viewpoint of sufficiently advancing the reaction. The reaction time may be, for example, within a range from 30 minutes to 24 hours, from 1 to 12 hours, or from 3 to 6 hours. The reaction time can be adjusted so as to obtain an expected reaction product by sampling a reaction product and measuring the number average molecular weight, concentration of a residual amino group or isocyanate group, and the like.

### <Insulating Material and Heat-Resistant Insulating Material>

In one or more embodiments of the present invention, an insulating material and a heat-resistant insulating material contain the block copolymer of any of the embodiments described above. The block copolymer can be preferably used as an insulating material or a heat-resistant insulating material because a polyimide obtained by using the block copolymer has excellent insulating properties and excellent heat-resistant insulating properties.

### <Composition>

In one or more embodiments of the present invention, a composition contains the block copolymer of any of the embodiments described above, and a solvent. An example of the solvent included in the composition is a solvent during the reaction described above which can be used for the synthesis of the block copolymer. The solvent preferably includes at least one selected from the group consisting of N-methyl-2-pyrrolidone (NMP), N-ethyl-2-pyrrolidone (NEP), γ-butyrolactone (GBL), and 3-methoxy-N,N-dimethylpropanamide (MPA), and more preferably includes at least one selected from the group consisting of N-ethyl-2-pyrrolidone (NEP), γ-butyrolactone (GBL), and 3-methoxy-N,N-dimethylpropanamide (MPA). The composition can be preferably used as a composition for an insulator, a composition for a heat-resistant insulator, or a composition for a printed board.

The composition may further contain an optional component, such as a polyamide, a polyethersulfone, an acrylic polymer, an epoxy compound, an isocyanate compound, a melamine compound, a filler, an antifoaming agent, a preservative, or a surfactant. The composition can be produced, for example, using a method of mixing the block copolymer, the solvent, and an optional component used as necessary and stirring the mixture.

The content of the block copolymer may be within a range suitable for the application of the composition. The content of the block copolymer is, for example, within a range from 5% to 50% by mass, from 8% to 40% by mass, or from 10% to 30% by mass, relative to the mass of the composition.

A viscosity of the composition at 30° C. is preferably within a range from 2 to 30 Pa s, more preferably from 5 to 20 Pa s, and even more preferably from 10 to 15 Pa s. In the present disclosure, the viscosity can be measured using a rotary type B viscometer at 30° C. using a No. 3 rotor.

### <Polyimide>

In one or more embodiments of the present invention, a polyimide can be obtained using the block copolymer of any of the embodiments described above, or the composition of any of the embodiments described above. For example, since the block copolymer includes the polyamic acid block (BA), the polyimide can be obtained by cyclizing an amic acid group and converting it to an imide group (in the present disclosure, this conversion may be referred to as “imidization”). A method for imidization is not particularly limited. In view of its simplicity, a method for heating the block copolymer can preferably be used. A heating temperature is, for example, within a range from 250° C. to 400° C.

The polyimide obtained from the block copolymer includes the polyimide block (BI) and the polyimide block (BI-A), which is a block where the polyamic acid block (BA) is imidized. The polyimide block (BI) and the polyimide block (BI-A) are different blocks. The polyimide exhibits a low coefficient of thermal expansion due to having a block structure. The polyimide exhibits a low permittivity and a low dielectric loss tangent due to having a hydrocarbon group (X). Further, the polyimide tends to exhibit a low water absorption due to having a hydrocarbon group (X).

The relative permittivity of the polyimide is, for example, 3.5 or less, 3.0 or less, or 2.5 or less, from the viewpoint of obtaining excellent insulating properties. The relative permittivity of the polyimide is not particularly limited, but is, for example, 2.0 or more. The relative permittivity (Dk) can be measured using a polyimide film (e.g., 25 μm thickness) with a cavity resonator method (TE mode) under conditions of a frequency of 10 GHz and a measurement temperature of 25° C. The relative permittivity (Dk) may be a value determined by measurement immediately after the polyimide film is sufficiently dried and left standing for 24 hours in the atmosphere at a temperature of 23° C. and a relative humidity of 50%.

The dielectric loss tangent of the polyimide is, for example, 0.0100 or less, 0.0050 or less, or 0.0020 or less, from the viewpoint of suppressing transmission loss. The dielectric loss tangent of the polyimide is not particularly limited, but is, for example, 0.0005 or more. The dielectric loss tangent (Df) can be measured using a polyimide film (e.g., 25 μm thickness) with a cavity resonator method (TE mode) under conditions of a frequency of 10 GHz and a measurement temperature of 25° C. The dielectric loss tangent (Df) may be a value determined by measurement immediately after the polyimide film is sufficiently dried and left standing for 24 hours in the atmosphere at a temperature of 23° C. and a relative humidity of 50%.

The coefficient of thermal expansion (CTE) of the polyimide is, for example, 80 ppm/K or less, 50 ppm/K or less, or 20 ppm/K or less, from the viewpoint of obtaining excellent heat resistance. The coefficient of thermal expansion of the polyimide is, for example, −5 ppm/K or more, 0 ppm/K or more, 10 ppm/K or more, or 15 ppm/K or more, considering that the polyimide film will be used attached to another material. The coefficient of thermal expansion (ppm/K) can be obtained through conversion of an average linear thermal expansion coefficient (ppm/° C.) at 30° C. to 200° C. measured with a thermomechanical analyzer using a polyimide film (e.g., 25 μm thickness) at a temperature increase rate of 10° C./min. The coefficient of thermal expansion may be, for example, 70 ppm/K or less, 60 ppm/K or less, 40 ppm/K or less, or 30 ppm/K or less.

The glass transition temperature (Tg) of the polyimide is, for example, 200° C. or more, 250° C. or more, or 300° C. or more, from the viewpoint of heat resistance of a compact. The glass transition temperature (Tg) of the polyimide is not particularly limited, but is, for example, 600° C. or lower. The glass transition temperature can be obtained as a temperature (° C.) corresponding to an inflection point in a linear thermal expansion coefficient curve of 30° C. to 200° C. measured with a thermomechanical analyzer using a polyimide film (e.g., 25 μm thickness) at a temperature increase rate of 10° C./min.

A water absorption percentage of the polyimide is, for example, 1.0% or less, 0.5% or less, or 0.3% or less, from the viewpoint of preventing a change in permittivity properties due to moisture absorption. The water absorption percentage of the polyimide is not particularly limited, but is, for example, 0.0% or more. The water absorption percentage (%) can be calculated using a formula below from the weight of a polyimide film (e.g., 25 μm thickness, 70 mm width, and 70 mm length) before and after soaking in water at 23° C. for 24 hours after drying.

Water absorption percentage (%)=(weight of polyimide film after water absorption−weight of polyimide film before water absorption)/weight of polyimide film before water absorption×100

More specifically, a relative permittivity, a dielectric loss tangent, a coefficient of thermal expansion, a glass transition temperature, and a water absorption percentage of the polyimide can be respectively measured according to methods described in examples by producing a polyimide film according to methods described in the examples and by using the produced polyimide film.

### <Compact, Insulator, and Heat Resistant Insulator>

In one or more embodiments of the present invention, a compact, insulator, and heat-resistant insulator are obtained using the block copolymer, material, or composition of any of the embodiments described above, or include the polyimide of the embodiments described above. The insulator preferably has a relative permittivity of 3.5 or less and a dielectric loss tangent of 0.0100 or less. It is preferable for the heat-resistant insulator that the relative permittivity be 3.5 or less, the dielectric loss tangent be 0.0100 or less, and the coefficient of thermal expansion be 80 ppm/K or less.

The shape of the compact, insulator, and heat-resistant insulator is not particularly limited, and may be a shape suitable for the application. For example, the compact, insulator, and heat-resistant insulator may be in the shape of a film, a plate, a membrane, a layer, or the like. The compact, insulator, and heat-resistant insulator can be used for various electronic components and mechanical components.

### <Printed Board>

In one or more embodiments of the present invention, a printed board is obtained using the block copolymer, material, or composition of any of the embodiments described above, or includes the polyimide, compact, insulator, or heat resistant insulator of the embodiments described above. The printed board of an embodiment of the present invention has low transmission loss and excellent heat resistance.

Examples of the printed board include a printed wiring board and a printed circuit board. Examples of the printed board include a flexible board and a rigid board. Examples of the printed board include a single-sided board, a double-sided board, and a multilayer board. For example, a substrate material, a protective film, an insulating layer, and the like of these boards are obtained by using the block copolymer, or include the polyimide or the like.

An example of the flexible board is a board including a base film that is obtained by using the block copolymer or includes the polyimide or the like. Another example of the flexible board is a board including a base film and a heat-resistant insulating layer formed on the base film, where at least the heat-resistant insulating layer is obtained by using the block copolymer, or includes the polyimide or the like.

### EXAMPLE EMBODIMENTS

Examples of embodiments of the present invention will be described below. The present invention is not limited to the following embodiments.

[1] A block copolymer, including:
a polyimide block (BI) and a polyamic acid block (BA); and
a structural unit (X) having a group (X) that includes at least one non-aromatic hydrocarbon group, where the total number of carbon atoms in the at least one non-aromatic hydrocarbon group is nine or more.
   [2] A block copolymer, including:
a polyimide block (BI) and a polyamic acid block (BA); and
at least one selected from the group consisting of a structural unit represented by formula (XI) below and a structural unit represented by formula (XA) below:

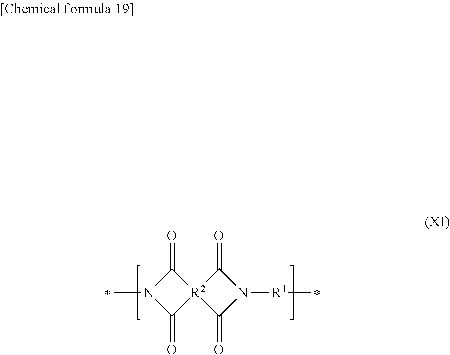

where, R¹ and R² each independently represent an organic group, and at least one of R¹ and R² is a group (X) that includes at least one non-aromatic hydrocarbon group, where a total number of carbon atoms in the at least one non-aromatic hydrocarbon group is nine or more;

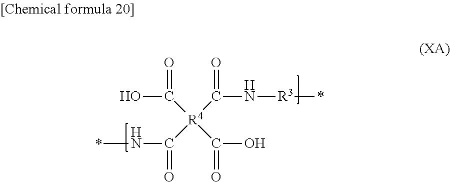

where R³ and R⁴ each independently represent an organic group, and at least one of R³ and R⁴ is a group (X) that includes at least one non-aromatic hydrocarbon group, where a total number of carbon atoms in the at least one non-aromatic hydrocarbon group is nine or more.

Or, a block copolymer satisfying [1] and [2] above.

[3] The block copolymer according to [2] above, further including at least one selected from the group consisting of a structural unit represented by formula (YI) below and a structural unit represented by formula (YA) below:

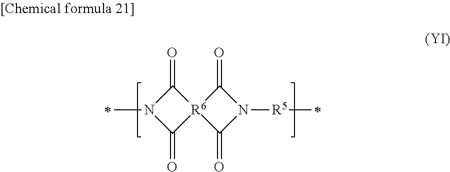

where R⁵ and R⁶ each independently represent an organic group (Y), and the organic group (Y) does not correspond with the group (X);

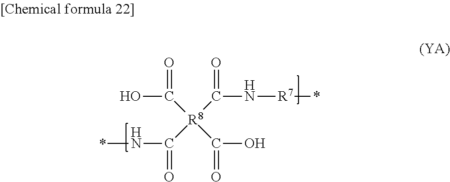

where R⁷ and R⁸ each independently represent an organic group (Y), and the organic group (Y) does not correspond with the group (X).
   [4] The block copolymer according to [3] above, wherein a content of the group (X) relative to a total mass of R¹ to R⁸ is within a range from 5% to 70% by mass.
   [5] The block copolymer according to [3] or [4] above, wherein, in the formula (YI) and the formula (YA), the organic group (Y) includes an aromatic hydrocarbon group.
   [6] The block copolymer according to any one of [3] to [5] above, wherein the polyamic acid block (BA) includes the structural unit represented by the formula (YA).
   [7] A block copolymer, including:
a polyimide block (BI) and a polyamic acid block (BA); and
a structure derived from a diamine or diisocyanate and a structure derived from a tetracarboxylic dianhydride, wherein
at least one of the structure derived from a diamine or diisocyanate and the structure derived from a tetracarboxylic dianhydride includes a structure having a group (X) that includes at least one non-aromatic hydrocarbon group, where the total number of carbon atoms in the at least one non-aromatic hydrocarbon group is nine or more.

Or a block copolymer satisfying [1] and [7] above, [2] and [7] above, or [1], [2], and [7] above.

[8] The block copolymer according to [7] above, wherein a content of the structure having a group (X) is within a range from 3% to 60% by mass relative to a total mass of the structure derived from a diamine or diisocyanate and the structure derived from a tetracarboxylic dianhydride.
[9] The block copolymer according to [7] or [8] above, wherein the structure derived from a diamine or diisocyanate includes a structure derived from a diamine or diisocyanate having a group (X), and a structure derived from a diamine or diisocyanate having an aromatic hydrocarbon group.
[10] The block copolymer according to [9] above, wherein the structure derived from a diamine or diisocyanate included in the polyamic acid block (BA) includes the structure derived from a diamine or diisocyanate having an aromatic hydrocarbon group.
[11] The block copolymer according to any one of [1] to [10] above, wherein the at least one non-aromatic hydrocarbon group is a saturated aliphatic hydrocarbon group, an unsaturated aliphatic hydrocarbon group, a saturated alicyclic hydrocarbon group, an unsaturated alicyclic hydrocarbon group, or a group consisting of two or more selected from these groups.
[12] The block copolymer according to any one of [1] to [11] above, wherein the group (X) is a saturated aliphatic hydrocarbon group where a number of carbon atoms is nine or more; an unsaturated aliphatic hydrocarbon group where a number of carbon atoms is nine or more; a saturated alicyclic hydrocarbon group where a number of carbon atoms is nine or more; an unsaturated alicyclic hydrocarbon group where a number of carbon atoms is nine or more; or a group consisting of two or more selected from a saturated aliphatic hydrocarbon group, an unsaturated aliphatic hydrocarbon group, a saturated alicyclic hydrocarbon group, and an unsaturated alicyclic hydrocarbon group, and where a number of carbon atoms is nine or more.
[13] The block copolymer according to any one of [1] to [12] above, wherein the group (X) includes a saturated alicyclic hydrocarbon group.
[14] The block copolymer according to any one of [1] to [13] above, wherein the group (X) includes a linear saturated aliphatic hydrocarbon group where a number of carbon atoms is six or more.
[15] The block copolymer according to any one of [1] to [14] above, wherein the number of the carbon atoms is 12 or more.
[16] The block copolymer according to any one of [1] to [15] above, wherein the number of the carbon atoms is 28 or more.
[17] The block copolymer according to any one of [1] to [16] above, wherein only one of the polyimide block (BI) and the polyamic acid block (BA) includes the group (X).
[18] The block copolymer according to any one of [1] to [16] above, wherein both the polyimide block (BI) and the polyamic acid block (BA) include the group (X).
[19] The block copolymer according to any one of [1] to [18] above, wherein the polyimide block (BI) has a number average molecular weight of 500 to 10,000.
[20] The block copolymer according to any one of [1] to [19] above, wherein the polyamic acid block (BA) has a number average molecular weight of 500 to 30,000.
[21] A method for producing a block copolymer, including:
obtaining a polyimide (PI) by using a diamine or diisocyanate and a tetracarboxylic dianhydride;
obtaining a polyamic acid (PA) by using a diamine and a tetracarboxylic dianhydride; and
obtaining a block copolymer by using the polyimide (PI) and the polyamic acid (PA), wherein
at least one selected from the group consisting of the diamine or diisocyanate, and the tetracarboxylic dianhydride, which are used to obtain the polyimide (PI), the diamine and the tetracarboxylic dianhydride, which are used to obtain the polyamic acid (PA), includes a compound having a group (X) that includes at least one non-aromatic hydrocarbon group, where the total number of carbon atoms in the at least one non-aromatic hydrocarbon group is nine or more.

Or a method for producing a block copolymer satisfying at least one of [1], [2], and [7] above, and satisfying [21] above.

[22] An insulating material, including the block copolymer according to any one of [1] to [20] above.
[23] A heat-resistant insulating material, including the block copolymer according to any one of [1] to [20] above.
[24] A composition, including the block copolymer according to any one of [1] to [20] above, and a solvent.
[25] A composition for an insulator, including the block copolymer according to any one of [1] to [20] or the insulating material according to [22], and a solvent.
[26] A composition for a heat-resistant insulator, including the block copolymer according to any one of [1] to [20] above or the heat-resistant insulating material according to [23] above, and a solvent.
[27] A composition for a printed board, including the block copolymer according to any one of [1] to [20] above, the insulating material according to [22] above, or the heat-resistant insulating material according to [23] above; and a solvent.
[28] A polyimide, obtained by using the block copolymer according to any one of [1] to [20] above, or the composition according to [24] above.
[29] A compact, obtained by using the block copolymer according to any one of [1] to [20] above, the insulating material according to [22] above, the heat-resistant insulating material according to [23] above, or the composition according to any one of [24] to [27] above; or including the polyimide according to [28] above.
[30] An insulator, obtained by using the block copolymer according to any one of [1] to [20] above, the insulating material according to [22] above, the heat-resistant insulating material according to [23] above, or the composition according to any one of [24] to [27] above; or including the polyimide according to [28] above.
[31] The insulator according to [30] above, having a relative permittivity of 3.5 or less, and a dielectric loss tangent of 0.0100 or less.
[32] A heat-resistant insulator, obtained by using the block copolymer according to any one of [1] to [20] above, the insulating material according to [22] above, the heat-resistant insulating material according to [23] above, or the composition according to any one of [24] to [27] above; or including the polyimide according to [28] above.
[33] The heat-resistant insulator according to [32] above, having a relative permittivity of 3.5 or less, a dielectric loss tangent of 0.0100 or less, and a coefficient of thermal expansion of 80 ppm/K or less.
[34] A printed board, obtained by using the block copolymer according to any one of [1] to [20] above, the insulating material according to [22] above, the heat-resistant insulating material according to [23] above, or the composition according to any one of [24] to [27] above; or including the polyimide according to [28] above, the compact according to [29] above, the insulator according to [30] or [31] above, or the heat-resistant insulator according to [32] or [33] above.
[35] In any one of the embodiments [1] to [34] above, the block copolymer includes at least one selected from the group consisting of a structural unit that is the group (X) represented by the formula (XI) where R¹ includes at least one non-aromatic hydrocarbon group, and the total number of carbon atoms in the at least one non-aromatic hydrocarbon group is 12 or more, and a structural unit that is the group (X) represented by the formula (XA) where R³ includes at least one non-aromatic hydrocarbon group, and the total number of carbon atoms in the at least one non-aromatic hydrocarbon group is 12 or more.
[36] In any one of the embodiments [1] to [35] above, the structure derived from a diamine or diisocyanate includes a structure having a group (X) where the number of carbon atoms is 12 or more.
[37] In any one of the embodiments [1] to [36], the total number of carbon atoms in the saturated aliphatic hydrocarbon group and the unsaturated aliphatic hydrocarbon group included in the group (X) is more than the total number of carbon atoms in the saturated alicyclic hydrocarbon group and the unsaturated alicyclic hydrocarbon group included in the group (X).
[38] In any one of the embodiments [1] to [37], the group (X) does not include an aromatic hydrocarbon group and an aromatic heterocyclic compound group.
[39] In any one of the embodiments [1] to [38], the number of carbon atoms is 16 or more.

The disclosure of the present application relates to the subject matter described in PCT/JP2023/017047 filed on May 1, 2023, the entire disclosed contents of which are incorporated herein by reference.

### EXAMPLES

Embodiments of the present invention will be specifically described with reference to examples. Embodiments of the present invention are not limited to the following examples.

### Synthesis of Polyimide (PI) and Polyamic Acid (PA)

### [Polyimide (PI-1)]

An amount of 62.3 g (0.12 mol) of a dimer diamine (PRIAMINE1075, Croda Japan K.K., including a dimer diamine represented by the following formula, hereinafter referred to as “DDA”) was dissolved in 400.0 g of a dimethylacetamide and 20.0 g of toluene to obtain a diamine solution. An amount of 29.0 g (0.13 mol) of a pyromellitic dianhydride (hereinafter referred to as “PMDA”) was added to the diamine solution and reacted until a uniform transparent solution was obtained. The reaction was performed by stirring the solution at 50° C. or lower for 1 hour or more. Then, the transparent solution was subjected to a dehydrothermal imidization reaction under stirring at 180° C. for 4 hours or more to obtain a solution (varnish) of a polyimide (PI-1) having an acid anhydride structure derived from PMDA at the terminals. The number average molecular weight of the polyimide (PI-1) was 6,100.

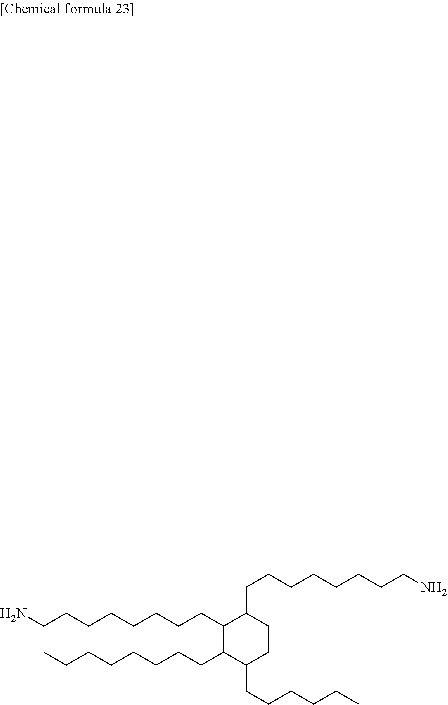 [SMILES: CCCCCCCCC1C(CCCCCC)CCC(CCCCCCCCN)C1CCCCCCCCN]

### [Polyimides (PI-2) to (PI-9)]

Solutions of polyimides (PI-2) to (PI-9) were obtained in the same manner as for the polyimide (PI-1), except that diamines and tetracarboxylic dianhydrides shown in Table 2 were used.

### [Polyamic Acid (PA-1)]

An amount of 32.6 g (0.30 mol) of a p-phenylenediamine (hereinafter referred to as “PPD”) was dissolved in 485.6 g of a dimethylacetamide to obtain a diamine solution. An amount of 84.9 g (0.29 mol) of a 3,3′,4,4′-biphenyltetracarboxylic dianhydride (hereinafter referred to as “BPDA”) was added to the diamine solution and reacted to obtain a solution of a polyamic acid (polyimide precursor) (PA-1) having an amine structure derived from PPD at the terminals. The reaction was performed by stirring the solution at 50° C. or lower for 8 hours or more. The number average molecular weight of the polyamic acid (PA-1) was 9,100.

### [Polyamic Acids (PA-2)-(PA-9)]

Solutions of polyamic acids (PA-2) to (PA-9) were obtained in the same manner as for the polyamic acid (PA-1), except that diamines and tetracarboxylic dianhydrides shown in Table 2 were used, and a dimethylacetamide and N-methyl-2-pyrrolidone were used as solvents.

### Synthesis of Block Copolymer (Block Polyamic Acid Imide)

### Example 1

An amount of 506.5 g of a solution of the polyimide (PI-1), and 603.1 g of a solution of the polyamic acid (PA-1) were mixed and reacted to obtain a varnish of a block polyamic acid imide 1. The reaction was performed by stirring the solution at 100° C. or lower for 1 hour or more. The number average molecular weight of the block polyamic acid imide 1 was 25,240. The concentration of the block polyamic acid imide 1 was 19.5% by mass relative to the weight of the varnish. The varnish is a composition containing the block copolymer and a solvent.

### Examples 2 to 9

Varnishes of block polyamic acid imides 2 to 9 were obtained in the same manner as in example 1, except that solutions of polyimides and polyamic acids shown in Table 2 were used.

### Synthesis of Polyamic Acid

### Comparative Example 1

An amount of 76.6 g (0.38 mol) of 4,4′-diaminodiphenyl ether (hereinafter referred to as “ODA”) was dissolved in 640.0 g of a dimethylacetamide to obtain a diamine solution. An amount of 81.8 g (0.38 mol) of a pyromellitic dianhydride (hereinafter referred to as “PMDA”) was added to the diamine solution and reacted to obtain a solution of a polyamic acid (polyimide precursor). The reaction was performed by stirring the solution at 50° C. or lower for 8 hours or more.

### Comparative Examples 2 to 6

Varnishes of polyamic acids 2 to 6 were obtained in the same manner as in comparative example 1, except that diamines and tetracarboxylic dianhydrides shown in Table 3 were used.

Tables 2 and 3 show the types and amounts of diamines and tetracarboxylic dianhydrides used for the synthesis of polyimides and polyamic acids, and polyimides and polyamic acids used for the synthesis of block polyamic acid imides. Tables 2 and 3 show the number average molecular weights of polyimides and polyamic acids. The number average molecular weights were determined according to the following method.

Meanings of abbreviations in Tables 2 and 3 are as follows.
PMDA: pyromellitic dianhydride
BTDA: 3,3′,4,4′-benzophenone tetracarboxylic dianhydride
BPDA: 3,3′,4,4′-biphenyltetracarboxylic dianhydride
DDA: dimer diamine
NBDA: bis(aminomethyl)norbornane
ODA: 4,4′-diaminodiphenyl ether
PPD: p-phenylenediamine
BODA: 4,4′-bis(4-aminophenoxy)biphenyl

TABLE 2

| | | | | Example 1 | | Example 2 | | Example 3 | | Example 4 | | Example 5 | | Example 6 | | Example 7 | | Example 8 | | Example 9 | |
|---|---|---|---|---|---|---|---|---|---|---|---|---|---|---|---|---|---|---|---|---|---|
| | | | | Mass | Content | Mass | Content | Mass | Content | Mass | Content | Mass | Content | Mass | Content | Mass | Content | Mass | Content | Mass | Content |
| | | | | (g) | (mass %) | (g) | (mass %) | (g) | (mass %) | (g) | (mass %) | (g) | (mass %) | (g) | (mass %) | (g) | (mass %) | (g) | (mass %) | (g) | (mass %) |
| Polyimide | Acid | PMDA | Organic | 29.0 | 13.9 | 29.0 | 14.2 | 8.7 | 9.0 | 36.5 | 19.6 | 17.6 | 17.8 | | | | | | | | |
| block | anhydride | | group (Y) | | | | | | | | | | | | | | | | | | |
| | | BTDA | Organic | | | | | | | | | | | 28.5 | 17.8 | 35.6 | 22.3 | 42.8 | 26.7 | 35.6 | 28.5 |
| | | | group (Y) | | | | | | | | | | | | | | | | | | |
| | Diamine | DDA | Group (X) | 62.3 | 29.9 | 62.3 | 30.5 | 16.0 | 16.5 | | | | | 35.5 | 22.2 | 44.4 | 27.7 | 53.2 | 33.3 | 44.4 | 35.4 |
| | | NBDA | Group (X) | | | | | | | | | 10.9 | 11.1 | | | | | | | | |
| | | ODA | Organic | | | | | | | 30.2 | 16.2 | | | | | | | | | | |
| | | | group (Y) | | | | | | | | | | | | | | | | | | |
| | Number average | | | Approx- | | Approx- | | Approx- | | Approx- | | Approx- | | Approx- | | Approx- | | Approx- | | Approx- | |
| | molecular weight | | | imately | | imately | | imately | | imately | | imately | | imately | | imately | | imately | | imately | |
| | | | | 6000 | | 6000 | | 3000 | | 4000 | | 3000 | | 3000 | | 3000 | | 3000 | | 3000 | |
| Polyamic | Acid | BPDA | Organic | 84.9 | 40.6 | 73.4 | 35.9 | 47.0 | 48.5 | 77.7 | 41.7 | 45.5 | 46.2 | 38.7 | 24.2 | 30.7 | 19.2 | 22.7 | 14.2 | 30.7 | 24.5 |
| acid block | anhydride | | group (Y) | | | | | | | | | | | | | | | | | | |
| | Diamine | DDA | Group (X) | | | 14.0 | 6.9 | 9.0 | 9.3 | 14.9 | 8.0 | 8.7 | 8.8 | | | | | | | | |
| | | PPD | Organic | 32.6 | 15.6 | 25.5 | 12.5 | 16.4 | 16.9 | 27.0 | 14.5 | 15.8 | 16.1 | | | | | | | 14.5 | 11.6 |
| | | | group (Y) | | | | | | | | | | | | | | | | | | |
| | | BODA | Organic | | | | | | | | | | | 57.3 | 35.8 | 49.3 | 30.8 | 41.3 | 25.8 | | |
| | | | group (Y) | | | | | | | | | | | | | | | | | | |

| | Number average | Approx- | Approx- | Approx- | Approx- | Approx- | Approx- | Approx- | Approx- | Approx- |
|---|---|---|---|---|---|---|---|---|---|---|
| | molecular weight | imately | imately | imately | imately | imately | imately | imately | imately | imately |
| | | 9000 | 9000 | 9000 | 9000 | 9000 | 4000 | 2500 | 2000 | 2000 |
| Polyamic | Number average | 25240 | 2516 | 24800 | 24320 | 24160 | 63970 | 56180 | 61990 | 63630 |
| acid imide | molecular weight | | | | | | | | | |
| Polyimide | Relative permittivity (Dk) | 3.0 | 3.0 | 2.8 | 2.6 | 2.8 | 3.1 | 3.0 | 2.9 | 2.9 |
| | Dielectric loss | 0.0062 | 0.0018 | 0.0015 | 0.0028 | 0.0084 | 0.0022 | 0.0020 | 0.0017 | 0.0029 |
| | tangent (Df) | | | | | | | | | |
| | Linear expansion | −2.2 | 24 | 21 | 31 | 18 | 39 | 58 | 60 | 7 |
| | coefficient (ppm/K) | | | | | | | | | |
| | Water absorption | 0.4 | 0.3 | 0.5 | 0.8 | 0.8 | 0.4 | 0.3 | 0.2 | 0.3 |
| | percentage (%) | | | | | | | | | |
| | Glass transition | 370 | 383 | 392 | 382 | 367 | 394 | 383 | 355 | 379 |
| | temperature (° C.) | | | | | | | | | |

TABLE 3

| | | | | Comparative | | Comparative | | Comparative | | Comparative | | Comparative | | Comparative | |
|---|---|---|---|---|---|---|---|---|---|---|---|---|---|---|---|
| | | | | example 1 | | example 2 | | example 3 | | example 4 | | example 5 | | example 6 | |
| | | | | | Content | | Content | | Content | | Content | | Content | | Content |
| | | | | Mass | (mass | Mass | (mass | Mass | (mass | Mass | (mass | Mass | (mass | Mass | (mass |
| | | | | (g) | %) | (g) | %) | (g) | %) | (g) | %) | (g) | %) | (g) | %) |
| Poly- | Acid | PMDA | Organic | 81.8 | 51.6 | | | 45.4 | 28.5 | | | 91.8 | 58.1 | 0.3 | 10.4 |
| amic | anhydride | | group (Y) | | | | | | | | | | | | |
| acid | | BPDA | Organic | | | 114.7 | 72.7 | | | 103.7 | 65.7 | | | 1.3 | 43.4 |
| | | | group (Y) | | | | | | | | | | | | |
| | Diamine | DDA | Group (X) | | | | | 113.7 | 71.5 | 19.2 | 12.2 | | | 0.9 | 30.6 |
| | | NBDA | Group (X) | | | | | | | | | 66.3 | 41.9 | | |
| | | ODA | Organic | 76.6 | 48.4 | | | | | | | | | | |
| | | | group (Y) | | | | | | | | | | | | |
| | | PPD | Organic | | | 43.0 | 27.3 | | | 35.0 | 22.2 | | | 0.5 | 15.5 |
| | | | group (Y) | | | | | | | | | | | | |

| | | | | | | | |
|---|---|---|---|---|---|---|---|
| | Number average | 20900 | 20100 | 37700 | 22300 | 18600 | 25200 |
| | molecular weight | | | | | | |
| Poly- | Relative permittivity (Dk) | 3.4 | 3.6 | 2.4 | 3.4 | 3.1 | 2.9 |
| imide | Dielectric loss tangent (Df) | 0.0164 | 0.0020 | 0.0018 | 0.0017 | 0.0184 | 0.0013 |
| | Linear expansion | 38 | 9.1 | 429 | 19 | 64 | 74 |
| | coefficient (ppm/K) | | | | | | |
| | Water absorption | 1.5 | 1.4 | 0.1 | 0.5 | 1.9 | 0.1 |
| | percentage (%) | | | | | | |
| | Glass transition | 385 | 420 | 72 | 410 | 295 | 368 |
| | temperature (° C.) | | | | | | |

### (Number Average Molecular Weight)

The number average molecular weight (Mn) was determined by measuring using gel permeation chromatography (GPC) and converting the value using a standard polystyrene calibration curve. The calibration curve was approximated by a cubic equation using five sample sets (TSK standard POLYSTYRENE, manufactured by Tosoh Corporation) of standard polystyrene. The conditions of GPC are as follows.
GPC equipment: high-speed GPC equipment HLC-8320GPC (manufactured by Tosoh Corporation)
Detector: Ultraviolet absorption detector UV-8320 (manufactured by Tosoh Corporation)
Column: Gelpack GL-S300MDT-5 (total 2 pieces) (manufactured by Resonac Holdings Corporation)

$$Eluent : THF / DMF = 1 / 1 ( volume ratio ) + LiBr ( 0.06 mol / L ) + {H}_{3} {PO}_{4} ( 0.06 mol / L )$$

Flow rate: 1 mL/min
Column size: 8 mm I.D.×300 mm
Sample concentration: 5 mg/1 mL
Injection volume: 5 μL
Measurement temperature: 40° C.

### <Production of Film>

### Example 1

Using the obtained varnish (composition), a film was produced according to the following procedure.

The surface of a commercially available glass substrate was degreased with acetone, and the varnish of the block polyamic acid imide 1 was applied in such a manner that the thickness of the imidized film was 25 μm using a film applicator with a film thickness adjusting function. The applied varnish was pre-dried using a hot plate at 80° C. for 60 minutes to form a layer of the block polyamic acid imide 1. Next, the layer of the block polyamic acid imide 1 was heated using an inert gas oven at 350° C. for 1 hour in a nitrogen atmosphere to form a film of a block polyimide 1. The glass substrate on which the film was formed was immersed in warm water for about 15 minutes, and then the film was peeled off from the glass substrate.

### Examples 2 to 9 and Comparative Examples 1 to 6

Films were obtained using the same method as described above, except that the varnish of the block polyamic acid imide 1 was changed to the varnishes of examples 2 to 9, and comparative examples 1 to 6.

### <Evaluation of Film>

Properties of films produced using the varnishes of examples 1 to 9, and comparative examples 1 to 6, were evaluated according to the following method. Tables 2 and 3 show the evaluation results. Examples 1 to 9 exhibited good results in terms of tensile strength, tensile modulus, and elongation at break.

### (Relative Permittivity and Dielectric Loss Tangent)

The film was cut into 60 mm×60 mm pieces, dried at 125° C. for 1 hour, and then left standing for 24 hours under conditions of a temperature of 23° C. and a relative humidity of 50%. Immediately afterward, the permittivity properties (relative permittivity Dk and dielectric loss tangent Df) of the film was measured using a cavity resonator method (TE mode). “MS46122B” manufactured by ANRITSU CORPORATION was used for the measurement. Conditions were set at a frequency of 10 GHz and a measurement temperature of 25° C.

### (Linear Thermal Expansion Coefficient (Coefficient of Thermal Expansion) and Glass Transition Temperature)

The film was cut into 4 mm in width and 25 mm in length to produce a test specimen. A thermomechanical analyzer (“TMA 7100” manufactured by Hitachi High-Tech Science Corporation) was used for the measurement. The test specimen was heated from room temperature to 350° C. at a rate of 10° C./min using a tension method with a chuck distance of 10 mm and a load of 10 g, and then cooled to 30° C. at a rate of 10° C./min. The temperature was raised again at a rate of 10° C./min, and an average linear thermal expansion coefficient (ppm/° C.) from 30° C. to 200° C. was calculated to define| the obtained value as the linear thermal expansion coefficient (ppm/K). A temperature corresponding to an inflection point of a linear thermal expansion coefficient curve was defined as the glass transition temperature (° C.).

### (Water Absorption Percentage)

The film was cut into a size of 70 mm in width and 70 mm in length to produce a test specimen. The test specimen was dried at 125° C. for 1 hour, and the weight of the test specimen was measured. Then, after the test specimen was immersed in water at 23° C. for 24 hours, the test specimen was taken out from water, and water on the surface was completely removed. The weight of the test specimen was measured one minute after taking out, and the weight increase before and after the test was determined. The water absorption percentage was calculated on the basis of the following equation.

$$Water absorption percentage ( \% ) = ( weight of specimen after water absorption - weight of specimen before water absorption ) / weight of specimen before water absorption \times 100$$

### (Tensile Strength, Tensile Modulus, and Elongation at Break)

The film was cut into a size of 10 mm in width and 60 mm in length to produce a test specimen. A tensile test was performed under the following measurement conditions, and the maximum tensile stress applied during the tensile test was defined as tensile strength (MPa). Elongation at break (%) was calculated by dividing elongation of a specimen until break by a chuck distance of 20 mm. Young's modulus (MPa) was calculated from a slope of an elastic deformation region at the initial stage of stress rise, and the obtained value was defined as tensile modulus (MPa). Other detailed conditions and calculation methods were performed in accordance with the international standard ISO 5271 (1993).
Equipment name: “Autograph AGS-100NG” (product name) manufactured by SHIMADZU CORPORATION
Test speed: 5 mm/min
Distance between chucks: 20 mm
Specimen size: width 10 mm, length 60 mm
Set temperature: room temperature (25° C.)

1. A block copolymer, comprising:
a polyimide block (BI) and a polyamic acid block (BA); and
a structural unit (X) having a group (X) that includes at least one non-aromatic hydrocarbon group, where a total number of carbon atoms in the at least one non-aromatic hydrocarbon group is nine or more.

2. A block copolymer, comprising:
a polyimide block (BI) and a polyamic acid block (BA); and
at least one selected from the group consisting of a structural unit represented by formula (XI) below and a structural unit represented by formula (XA) below: 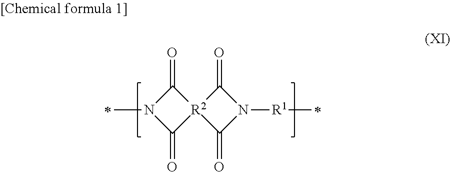
where R¹ and R² each independently represent an organic group, and at least one of R¹ and R² is a group (X) that includes at least one non-aromatic hydrocarbon group, where a total number of carbon atoms in the at least one non-aromatic hydrocarbon group is nine or more; 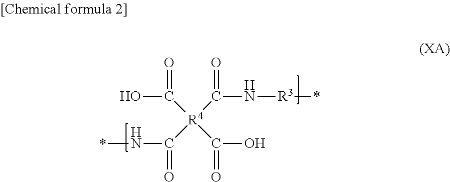
where R³ and R⁴ each independently represent an organic group, and at least one of R³ and R⁴ is a group (X) that includes at least one non-aromatic hydrocarbon group, where a total number of carbon atoms in the at least one non-aromatic hydrocarbon group is nine or more.

3. The block copolymer according to claim 2, further comprising at least one selected from the group consisting of a structural unit represented by formula (YI) below and a structural unit represented by formula (YA) below: 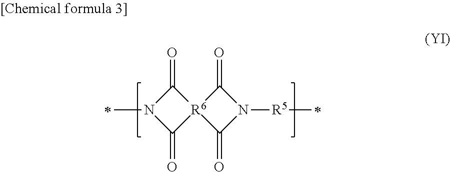
where R⁵ and R⁶ each independently represent an organic group (Y), and the organic group (Y) does not correspond with the group (X); 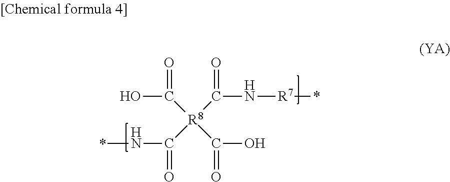
where R⁷ and R⁸ each independently represent an organic group (Y), and the organic group (Y) does not correspond with the group (X).

4. The block copolymer according to claim 3, wherein a content of the group (X) relative to a total mass of R¹ to R⁸ is within a range from 5% to 70% by mass.

5. The block copolymer according to claim 3, wherein, in the formula (YI) and the formula (YA), the organic group (Y) includes an aromatic hydrocarbon group.

6. The block copolymer according to claim 5, wherein the polyamic acid block (BA) includes the structural unit represented by the formula (YA).

7. A block copolymer, comprising:
a polyimide block (BI) and a polyamic acid block (BA); and
a structure derived from a diamine or diisocyanate and a structure derived from a tetracarboxylic dianhydride, wherein
at least one of the structure derived from a diamine or diisocyanate and the structure derived from a tetracarboxylic dianhydride includes a structure having a group (X) that includes at least one non-aromatic hydrocarbon group, where the total number of carbon atoms in the at least one non-aromatic hydrocarbon group is nine or more.

8. The block copolymer according to claim 7, wherein a content of the structure having a group (X) is within a range from 3% to 60% by mass relative to a total mass of the structure derived from a diamine or diisocyanate and the structure derived from a tetracarboxylic dianhydride.

9. The block copolymer according to claim 7, wherein the structure derived from a diamine or diisocyanate includes a structure derived from a diamine or diisocyanate having a group (X), and a structure derived from a diamine or diisocyanate having an aromatic hydrocarbon group.

10. The block copolymer according to claim 9, wherein the structure derived from a diamine or diisocyanate included in the polyamic acid block (BA) includes the structure derived from a diamine or diisocyanate having an aromatic hydrocarbon group.

11. The block copolymer according to claim 1, wherein the at least one non-aromatic hydrocarbon group is a saturated aliphatic hydrocarbon group, an unsaturated aliphatic hydrocarbon group, a saturated alicyclic hydrocarbon group, an unsaturated alicyclic hydrocarbon group, or a group consisting of two or more selected from these groups.

12. The block copolymer according to claim 1, wherein the group (X) is a saturated aliphatic hydrocarbon group where a number of carbon atoms is nine or more; an unsaturated aliphatic hydrocarbon group where a number of carbon atoms is nine or more; a saturated alicyclic hydrocarbon group where a number of carbon atoms is nine or more; an unsaturated alicyclic hydrocarbon group where a number of carbon atoms is nine or more; or a group consisting of two or more selected from a saturated aliphatic hydrocarbon group, an unsaturated aliphatic hydrocarbon group, a saturated alicyclic hydrocarbon group, and an unsaturated alicyclic hydrocarbon group, and where a number of carbon atoms is nine or more.

13. The block copolymer according to claim 1, wherein the group (X) includes a saturated alicyclic hydrocarbon group.

14. The block copolymer according to claim 1, wherein the group (X) includes a linear saturated aliphatic hydrocarbon group where a number of carbon atoms is six or more.

15. The block copolymer according to claim 1, wherein the number of the carbon atoms is 12 or more.

16. The block copolymer according to claim 1, wherein the number of the carbon atoms is 28 or more.

17. The block copolymer according to claim 1, wherein only one of the polyimide block (BI) and the polyamic acid block (BA) includes the group (X).

18. The block copolymer according to claim 1, wherein both the polyimide block (BI) and the polyamic acid block (BA) include the group (X).

19. The block copolymer according to claim 1, wherein the polyimide block (BI) has a number average molecular weight of 500 to 10,000.

20. The block copolymer according to claim 1, wherein the polyamic acid block (BA) has a number average molecular weight of 500 to 30,000.

21. A method for producing a block copolymer, comprising:
obtaining a polyimide (PI) by using a diamine or diisocyanate and a tetracarboxylic dianhydride;
obtaining a polyamic acid (PA) by using a diamine and a tetracarboxylic dianhydride; and
obtaining a block copolymer by using the polyimide (PI) and the polyamic acid (PA), wherein
at least one selected from the group consisting of the diamine or diisocyanate and the tetracarboxylic dianhydride, which are used to obtain the polyimide (PI), and the diamine and the tetracarboxylic dianhydride, which are used to obtain the polyamic acid (PA), includes a compound having a group (X) that includes at least one non-aromatic hydrocarbon group, where the total number of carbon atoms in the at least one non-aromatic hydrocarbon group is nine or more.

22. An insulating material, comprising the block copolymer according to claim 1.

23. A heat-resistant insulating material, comprising the block copolymer according to claim 1.

24. A composition, comprising the block copolymer according to claim 1, and a solvent.

25. A composition for an insulator, comprising the block copolymer according to claim 1, and a solvent.

26. A composition for a heat-resistant insulator, comprising the block copolymer according to claim 1, and a solvent.

27. A composition for a printed board, comprising the block copolymer according to claim 1; and a solvent.

28. A polyimide, obtained by using the block copolymer according to claim 1.

29. A compact, obtained by using the block copolymer according to claim 1.

30. An insulator, obtained by using the block copolymer according to claim 1.

31. The insulator according to claim 30, having a relative permittivity of 3.5 or less, and a dielectric loss tangent of 0.0100 or less.

32. A heat-resistant insulator, obtained by using the block copolymer according to claim 1.

33. The heat-resistant insulator according to claim 32, having a relative permittivity of 3.5 or less, a dielectric loss tangent of 0.0100 or less, and a coefficient of thermal expansion of 80 ppm/K or less.

34. A printed board, obtained by using the block copolymer according to claim 1.
